(19) United States
(12) Patent Application Publication
(10) Pub. No.: US 2021/0180862 A1
(43) Pub. Date: Jun. 17, 2021

(54) CRACKER MODULAR PROCESSING FACILITY

(71) Applicant: Fluor Technologies Corporation, Sugar Land, TX (US)

(72) Inventors: Fred HANEY, Calgary (CA); Gary DONOVAN, Calgary (CA); Todd ROTH, Calgary (CA); Alan LOWRIE, Calgary (CA); George MORLIDGE, Alberta (CA); Simon LUCCHINI, Calgary (CA); Sean HALVORSEN, Calgary (CA)

(73) Assignee: Fluor Technologies Corporation, Sugar Land, TX (US)

(21) Appl. No.: 16/759,195

(22) PCT Filed: Oct. 31, 2018
(86) PCT No.: PCT/US2018/058358

§ 371 Date: Apr. 24, 2020

Related U.S. Application Data
(60) Provisional application No. 62/579,560, filed on Oct. 31, 2017.

(51) Int. Cl. F25J 3/02; B01J 12/00; E04H 1/00

(52) U.S. Cl. CPC F25J 3/0238; B01J 12/005; F25J 3/0219; E04H 1/005; B01J 2219/0002; F25J 2290/60; F25J 2205/30; F25J 2215/62; F25J 2290/20; F25J 2290/42; B01J 2219/00006

(57) ABSTRACT

The various processes of an ethane cracker plant may be segmented into separate process blocks, which may be interconnected using fluid conduits and/or electrical connections. These process blocks may be directly connected, for example without an external piperack or other external piping interconnecting process blocks. Each process block may be formed of one or more modules The process blocks can include an ethane cracking furnace, a steam generation process, a water stripper, a water quench, a compression, a caustic scrubber, a drier, a deethanizer, an acetylene conversion, a demethanizer, a refrigerator, or a splitter.

### CROSS-REFERENCE TO RELATED APPLICATIONS

This application claims priority to U.S. Provisional Patent Application Ser. No. 62/579,560 entitled “Cracker Modular Processing Facility” filed Oct. 31, 2017, which is incorporated herein by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

This disclosure is generally related to the modular construction of process facilities, with particular examples given with respect to modular steam cracker processing facilities (although the modular construction described herein may apply to other types of processing facilities).

### BACKGROUND

In the engineering industry, a petrochemical plant that uses energy to break apart (e.g., crack) molecules to form new molecules is called a cracker. Generally, the cracker process may widely differ depending on the type of feedstock used (e.g., natural gas liquids (NGLs) such as ethane, propane, and butane; naphtha, light gas oil, etc.). In recent years, due to technological advancements such as shale development, several petrochemical manufacturers have discovered an abundance of NGLs in shale plays like the Marcellus, Bakken, Utica, and Eagle Ford. Since ethane is a major component of NGLs, the cost of ethane due to a significant increase in availability has decreased. With this newfound low cost of energy and ethane, manufacturers seek to expand steam cracking abilities to form ethylene from ethane feedstock.

Steam cracking may be used to convert ethane to ethylene and, additionally, propylene. The worldwide demand for ethylene is ever-increasing. Ethylene serves as a building block in producing a variety of other chemicals (e.g., polyvinylchloride (PVC), ethylbenzene, ethylene oxide, ethylene glycol, polyethylene terephthalate, etc.) used to manufacture products such as construction materials (e.g., piping for plumbing, siding for houses, decking, etc.), Styrofoam, automobile tires, surfactants, detergents, antifreeze, polyester, and beverage bottles. Thus, ethylene is typically seen as a basic commodity similar to electricity or water because it may be used to form various finished goods and consumer products. However, conventional steam cracking facilities can be extraordinarily challenging to build especially in remote locations or under adverse conditions. Additionally, conventional steam cracking facilities may require up to millions of hours of work on-site leading to higher labor risks and higher set-up costs.

Given the difficulties of building a facility entirely on-site, there has been considerable interest in 2nd Generation Modular Construction. In that technology, a facility is logically segmented into modules. The modules are constructed in an established industrial area, trucked or airlifted to the plant site, and then coupled together at the plant site (typically via a piperack (external piping) interconnecting the 2^{nd} Gen modules (“2^{nd} Gen”)). Typically such 2^{nd} Gen modules are not process based, but rather are equipment based, meaning that each of the modules in a 2^{nd} Gen Construction typically relates to a specific equipment type (e.g., pumps, compressors, heat exchangers, cooling towers, etc.). Several 2^{nd} Gen Modular Construction facilities are in place in the tar sands of Alberta, Canada, and they have been proved to provide numerous advantages in terms of speed of deployment, construction work quality, reduction in safety risks, and overall project cost.

2^{nd} Gen Modular facilities have also been described in patent literatures. An example of a large capacity oil refinery composed of multiple, self-contained, interconnected, and modular refining units is described in WO 03/031012 to Shumway. A generic 2^{nd} Gen Modular facility is described in US 2008/0127662 to Stanfield.

Unless otherwise expressly indicated herein, WO 03/031012, US 2008/0127662, and all other extrinsic materials discussed herein, and in the priority specification and attachments, are incorporated by reference in their entirety. Where a definition or use of a term in an incorporated reference is inconsistent with or contrary to the definition and/or usage of that term provided herein, the definition or usage of that term provided herein applies, and the definition of that term in the reference does not apply.

### SUMMARY

In some embodiments, a modular processing facility comprises at least 3 process blocks. The at least 3 process blocks are non-identical process blocks, and the at least 3 process blocks each comprise one or more modules. Each process block of the at least 3 process blocks is interconnected to one or more of the other at least 3 process blocks, and the at least 3 process blocks comprise the following: an ethane cracking furnace, a steam generation process, a water stripper, a water quench, a compression, a caustic scrubber, a drier, a deethanizer, an acetylene conversion, a demethanizer, a refrigerator, or a splitter.

In some embodiments, a method of constructing a modular facility comprises arranging a plurality of process blocks with respect to one another, directly interconnecting each process block to one or more adjacent process blocks, and configuring each process block to accomplish a corresponding process. The plurality of process blocks are non-identical process blocks, and the plurality of process blocks each comprise one or more modules. The plurality of process blocks comprise at least 3 of: an ethane cracking furnace process block, a water quench process block, a water stripper process block, a cracked gas compression process block, a caustic treatment process block, a drying process block, a deethanizer process block, an acetylene conversion process block, a demethanizer process block, a refrigeration process block, or a C₂ splitter process block.

In some embodiments, a facility comprises a first process block, a second process block, and a third process block. The first process block, the second process block, and the third process block are coupled together, and at least 3 transportable modules are used to collectively compose the first process block, the second process block, and the third process block. Each of the first process block, the second process block, and the third process block is fluidly and electrically coupled to at least one other of the first process block, the second process block, and the third process block using direct-module-to-module connections, and no external piperack interconnects the first process block, the second process block, and the third process block. The first process block is positioned adjacent to each of the second process block and the third process block, and the first process block is configured to carry out a first process and the second process block is configured to carry out a second process different from the first process.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a flowchart showing some of the steps involved in a 3^{rd} Gen Construction process.

FIG. 2 is an example of a 3^{rd} Gen Construction process block showing a first level grid and equipment arrangement.

FIG. 3 is a simple 3^{rd} Gen Construction “block” layout.

FIG. 4 is a schematic of a basic cracker block flow diagram.

FIG. 5 is an alternative schematic of a basic cracker block flow diagram.

FIG. 6 is a schematic of an exemplary process block layout in an ethylene cracker facility showing general input and output flows for each process block.

FIG. 7 is an alternative schematic of an exemplary process block layout in an ethylene cracker facility showing general input and output flows for each process block.

FIG. 8 is a schematic of three exemplary process blocks in an oil separation facility designed for the oil sands region of western Canada.

FIG. 9 is a schematic of a process block module layout elevation view, in which modules three modules are on one level, most likely ground level, with a fourth module disposed on a second level.

FIG. 10 is a schematic of an oil treating process block showing three modules, plus two additional modules disposed in a second story.

FIG. 11 is a schematic of a 3^{rd} Gen Modular facility having four process blocks, each of which has five modules.

FIG. 12 is a schematic of another 3rd Generation Modular facility having a total of six interconnected process blocks.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field (for example, +/−10%); and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The terms “commissioning” and “pre-commissioning” refer to processes and procedures for bringing a system, component, module, process block, piece(s) of equipment, etc. in to working condition. These terms may include testing to verify the function of a given system, component, module, process block, piece(s) of equipment, according to the design specifications and objectives.

The term “process” is used herein in the manner that one of ordinary skill (i.e., a process engineer) would use the term for individual processes in a process block layout of a processing facility. In addition, a process carried out within a process block may include one or more “unit operations” which include a physical change and/or chemical transformation in a given process flow (e.g., fluid or solid flow).

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

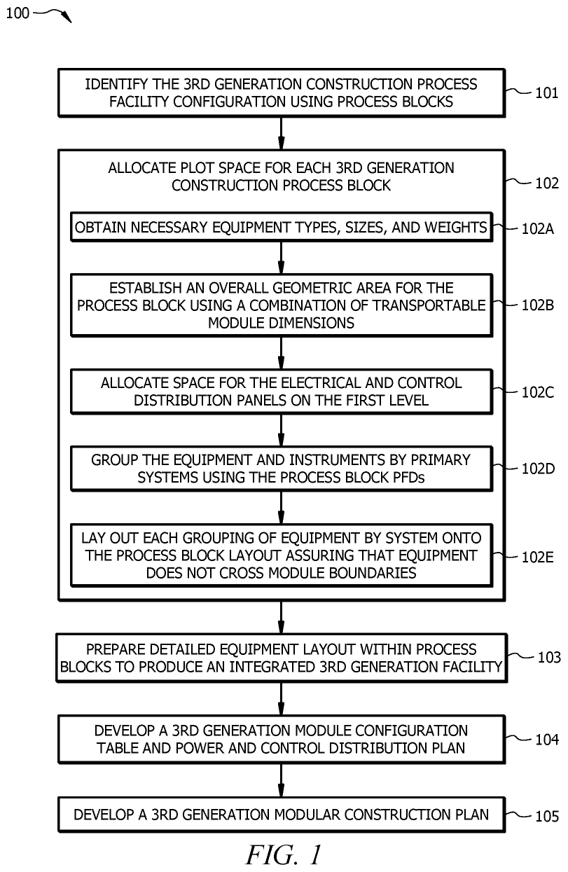

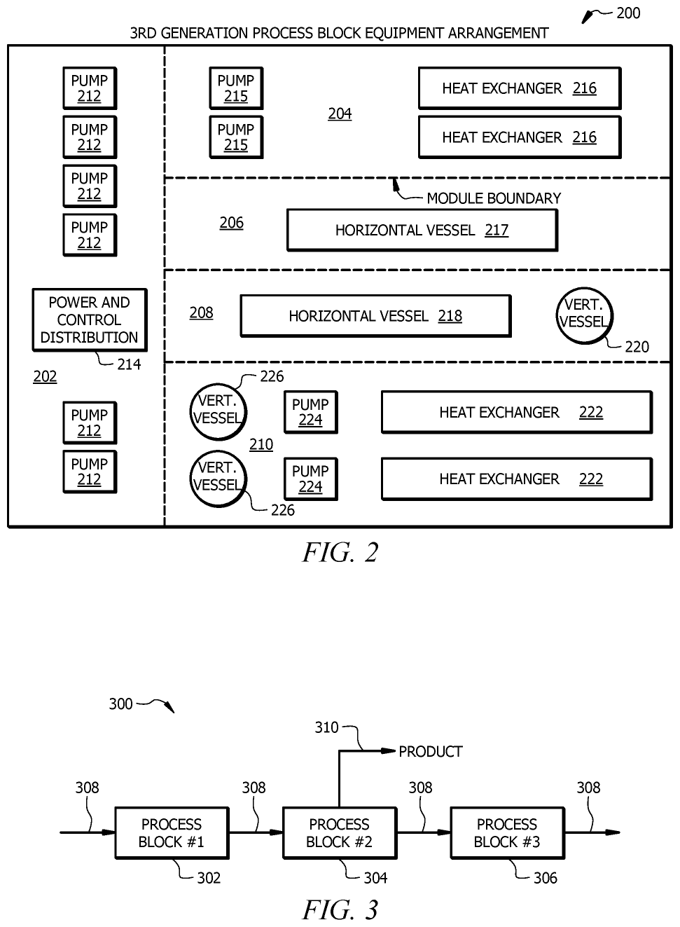

There have been significant cost savings in using 2^{nd} Gen Modular approaches. It is contemplated, for example, that building of a process module costs $4 (US) in the field for every $1 (US) spent building an equivalent module in a construction facility. Nevertheless, despite the many advantages of 2^{nd} Gen Modular, there are still problems. Serious problems may arise from the ways in which the various modules are inter-connected. In 2^{nd} Gen Modular units, the fluid, power, and control lines between modules are carried by external piperacks. This can be seen clearly in FIGS. 1 and 2 of WO 03/031012, for example. In facilities using multiple, self-contained, substantially identical production units, it is logically simple to operate those units in parallel, and to provide feed (inflow) and product (outflow) lines along an external piperack. However, where small production units are impractical or uneconomical, the use of external piperacks can be a hindrance. For example, not only does the 2^{nd} Gen usage of one or more external piperacks typically result in the utilization of more piping and additional work in the field to interconnect modules, external piperacks interconnecting modules (and/or the use of equipment-based modules) may also typically severely limit the amount of pre-commissioning, check out, and/or commissioning of modules individually and/or before they are installed at the ultimate site of the facility (e.g., at a construction facility in an industrial area remote from the ultimate site of the entire process facility). This limitation typically arises due to the equipment-based nature of 2^{nd} Gen modules as described above, which does not lend itself to stand-alone pre-commissioning, check-out, and/or commissioning (because in order for a process to be performed using such equipment-based 2^{nd} Gen modules, the modules would have to be interconnected with other modules in a way that forms a process which can be evaluated effectively as a whole). This may also especially be true since typical 2^{nd} Gen modules do not have integrated electrical and instrumentation (E+I) systems in each module, but instead, typically are connected to a centralized E+I system (for example via home run interconnecting cabling through traditional interconnecting racks).

What is needed is a new modular paradigm, in which the various processes of a cracker plant are segmented into process blocks, where each process block comprises one or more (typically multiple) modules. Each such process block typically has a plurality of different types of equipment relating to different engineering disciplines, all working together to jointly perform an overarching process. And typically, the process blocks are configured to allow for off-site (e.g., stand-alone pre-commissioning, check-out and/or commissioning, for example at a site away from the ultimate site and/or away from the site of other process blocks). Also, in forming a 3^{rd} Gen facility, the process blocks are typically interconnected without external piperacks (and most typically without any external piping therebetween, rather having direct connections which are typically located within the envelope (opening) of the relevant process blocks). This document refers to such designs and implementations as 3rd Generation (“3^{rd} Gen”) Modular Construction or as 3^{rd} Gen processing facilities, as further discussed below.

The disclosed subject matter provides apparatus, systems, and methods in which the various processes of a cracker plant are segmented into process blocks, each process block comprising one or more (typically multiple) modules, wherein at least some of the modules within at least some of the process blocks are fluidly and electrically coupled to at least another of the modules using direct-module-to-module connections (e.g., without external piping).

Typically, embodiments of a 3^{rd} Gen processing facility would be constructed (for example modularly) by coupling together at least two process blocks. In preferred embodiments, a processing facility might be constructed at least in part by coupling together three or more process blocks. In some embodiments, each of at least two of the blocks comprises at least two truckable modules, and more preferably three, four, five, or even more such modules. Contemplated embodiments can be rather large, and can have four, five, ten, or even twenty or more process blocks, which collectively might comprise up to a hundred, two hundred, or even a higher number of truckable modules in some embodiments. Other embodiments may have process blocks comprising one or more transportable modules. All manner of industrial processing facilities are contemplated, including nuclear, gas-fired, coal-fired, or other energy producing facilities, chemical plants, petrochemical plants, and mechanical plants. And while 3^{rd} Gen techniques might be used for some off-shore modular construction, more often 3^{rd} Gen modules and construction techniques would be used to construct on-shore processing facilities.

As used herein the term “process block” means a part of a processing facility that has several process systems within a distinct geographical boundary. Typically, each process block is configured to achieve a single (stand-alone) process, for example of the sort that a process engineer might use in a process block layout. Thus, the term “process” in this context is utilized in the manner that one of ordinary skill (e.g., a process engineer) would use the term for individual processes in a process block layout of a processing facility. A process carried out within a process block may include one or more unit operations (e.g., a physical change and/or chemical transformation), and typically a process block might comprise two or more unit operations. So in at least some embodiments, a process block includes multiple pieces and types of equipment (e.g., pumps, compressors, vessels, heat exchangers, vessels, coolers, blowers, reactors, etc., for example) for carrying out a plurality of unit operations within a contiguous, defined geographical area (i.e., the geographical area defined by the corresponding process block). In addition, in at least some embodiments the process blocks (e.g., the multiple pieces and types of equipment as well as the multiple unit operations) would be arranged and designed to support or relate to at least one common, overarching process, for example relating to the primary process flow of the production facility as a whole. Typically, each process block would have its own self-supporting (e.g., independent) E+I. Due to such features, each process block may be operable or configured for independent pre-commissioning, check-out, and/or commissioning (for example, with respect to E+I of the relevant process block). Thus, each process block may be independently pre-commissioned, checked-out, and/or commissioned with respect to E+I, for example at a site remote from the ultimate/final site of the overall facility and/or without interconnection with any other process block and/or module and/or equipment. Each process block typically accepts specific feed(s) and processes such feed(s) into one or more products (e.g., outputs). In some instances, one or more of the feed(s) for a specific process block may be provided from other process blocks(s) (e.g., the products from one or more other interconnected process blocks) in the facility, and in some instances the products from a specific process block might serve as inputs or feeds into one or more other process blocks of a facility.

In the hydrocarbon and chemical business, a process block can comprise equipment, such as processing columns, reactors, vessels, drums, tanks, filters, as well as pumps or compressors to move fluid(s) through the processing equipment including heat exchangers and heaters for heat transfer to or from the fluid(s). The type and arrangement of equipment within the defined geographic area of a given process block is designed to carry out the specific process(es) with the feed for that process block (i.e., the equipment arranged within the process block is chosen and arranged to facilitate the designed process(es) of the process block and is not simply grouped by equipment type such as would be found in a 2^{nd} Gen modular construction). A process block typically might inherently have a series of piping systems and controls to interconnect the equipment within the process block. By eliminating the traditional interconnecting piperack (e.g., external piping of 2^{nd} Gen), the 3^{rd} Gen approach may facilitate an efficient systems-based layout resulting in the reduction of piping quantities. For solid material processing facilities, such as mineral processing, the piping systems described above would typically be replaced with material handling equipment (e.g., conveyors, belts, elevators, etc.). In the 3^{rd} Gen approach, a process block may include, for example, 20 to 30 pieces of equipment, but there could be more or less pieces of equipment in some process block embodiments. Typically, all equipment for a specific process may be located within a single (for example, contiguous) geographic footprint and/or envelope. Thus, the inputs/feeds for a specific process block may typically be the inputs needed for the process (as a whole), and the outputs for the process block may typically be the outputs resulting from the process (as a whole). Thus, the actual process may be self-contained within the corresponding process block. And typically, each such process block is configured to achieve a distinct/different process (which may include one or more unit operations as previously described). While some process facilities might comprise only two process blocks, more typical process facilities may comprise at least 2 process blocks (and in some embodiments, at least 3, at least 5, at least 7, at least 10, or at least 15 process blocks), with each of the at least 2 process blocks being non-identical (e.g., each of the at least 2 process blocks may be configured for a different process) (e.g., not simply multiple, substantially identical modules, for example in parallel). So while there may be some amount of duplication of process blocks (for example, for scaling purposes) in 3^{rd} Gen, it is typically true of 3^{rd} Gen processing facilities that they include at least 2 different modular process blocks, which may be interconnected (for example via piping and/or electrical lines) in forming the entire facility. By way of example, a facility might have one or more process blocks for: generation of steam, distillation, scrubbing, separating one material from another, crushing, grinding, and/or performing other mechanical operations, performing chemical reactions with or without the use of catalysts, cooling, and the like. More specifically, a steam cracker facility may include one or more process blocks for steam generation, ethane cracking (e.g., via furnaces), quenching, compressing cracked gas, dilution, stripping water, caustic treatment, drying, demethanizing, deethanizing, converting acetylene, cooling, splitting ethylene, and the like.

As used herein, the term “truckable module” means a section of a process block that includes multiple pieces of equipment and has a transportation weight between 20,000 kilograms (Kg) and 200,000 Kg. The concept is that a commercially viable subset of truckable modules would be large enough to practically carry the needed equipment and support structures, but would also be suitable for transportation on commercially-used roadways in a relevant geographic area, for a particular time of year. It is contemplated that a typical truckable module for Western Canada tar sands areas would be between 30,000 Kg and 180,000 Kg, and more preferably between 40,000 Kg and 160,000 Kg. From a dimensions perspective, such modules would typically measure between 15 and 30 meters long, and at least 3 meters high and 3 meters wide, but no more than 35 meters long, 8 meters wide, and 8 meters high. While some embodiments may employ one or more truckable modules, other embodiments may employ one or more transportable modules. Transportable modules are modules (e.g., sections of a process block or an entire process block including multiple pieces of equipment) operable to be transported using one or more means for transport. “Transportable module” is intended to be a broader term than “truckable module,” such that the term typically includes truckable modules, for example, but also includes larger modules that would not be considered truckable. So for example, a transportable module might be at least 30,000 Kg or at least 40,000 Kg. In some embodiments, a transportable module might be up to 6,000,000 Kg, or even more (for example, for very large modules). In some embodiments, a transportable module might be between 30,000 Kg and 6,000,000 Kg, between 30,000 Kg and 500,000 Kg or between 40,000 Kg and 350,000 Kg. From a dimensions perspective, such transportable modules would typically measure at least 15 meters long, at least 3 meters wide, and at least 3 meters high, or in other embodiments at least 15 meters long, at least 4 meters wide, and at least 4 meters high.

Truckable and/or transportable modules may be closed on all sides, and on the top and bottom, but more typically such modules would have at least one open side, and possibly all four open sides, as well as an open top. The open sides allow modules to be positioned adjacent to one another at the open sides, thus creating a large open space, comprising 2, 3, 4, 5 or even more modules, through which an engineer operator, or other personnel could walk from one module to another, for example within a process block.

A typical truckable and/or transportable module may include equipment from multiple disciplines, as for example, process and staging equipment, platforms, wiring, instrumentation, and lighting.

One significant advantage of 3^{rd} Gen Modular Construction is that process blocks are designed to have only a relatively small number of external couplings. In some embodiments, for example, there are at least two process blocks that are fluidly coupled by no more than three (3), four (4), or five (5) fluid lines, excluding utility lines. However, there could be two or more process blocks that are coupled by six (6), seven (7), eight (8), nine (9), ten (10), or more fluid lines, excluding utility lines. Each process block may include its own integrated E+I system such that E+I lines (e.g., cables, wires, etc.), for each process block, are routed through the modules of that process block. Fluid, power, and control lines coming into a process block may “fan out” (extend into different directions from a single point) to various modules within the process block. The term “fan out” is not meant in a narrow literal sense, but in a broader sense to include situations where, for example, a given fluid line splits into smaller lines that carry a fluid to different parts of the process block through orthogonal, parallel, and other line orientations. As used herein, “utility lines” refers to lines (e.g., pipes, conduits, tubes, hoses, etc.) for carrying fluids (i.e., liquids and gases) that facilitate the chemical and/or physical processes within one or more process blocks. For example, the fluid carried by a utility line may include air, nitrogen (N₂), oxygen (O₂), water (H₂O), steam, etc. The term “utility line” does not include electrical or instrumentation cables, lines, wires, etc. (e.g., such as would be associated within the E+I system).

Process blocks can be assembled in any suitable manner. The arrangement of the process blocks may change depending on the site plan available, but, generally, the process block arrangement may be similar in order to optimize flow through the facility. For example, in some embodiments, 3^{rd} Gen process blocks are arranged and interconnected with one another without an external piperack (so for example, the process blocks would not be laid out with a piperack backbone connecting the process modules, as may be fairly typical in 2^{nd} Gen modular design, for example). Instead, in these embodiments, the 3^{rd} Gen process blocks typically are directly interconnected with one another in accordance with a 3^{rd} Gen Construction block layout, for example. In other words, each of the process blocks typically would be arranged/positioned in proximity (for example, oftentimes abutting) with one or more process blocks with which it interacts (e.g., with inputs and outputs directly interconnecting the process blocks), without intervening external interconnecting piperack(s) and/or process blocks there between. In some embodiments all of the process blocks might be positioned and/or interconnected in this manner (e.g., in proximity with and directly interconnected with the other process blocks with which it interacts). In other embodiments, only some of the process blocks (e.g., 3 or more, 5 or more, 8 or more, or 10 or more process blocks) may be so arranged and/or interconnected (and other process blocks might be arranged and/or interconnected differently). For example, in some embodiments, the process blocks for the primary process flow may all be positioned and/or interconnected, even though one or more other process blocks may be positioned in such a way as to require interconnection through an unrelated process block. This direct connection between interconnected process blocks may allow for close coupling of the process blocks, for example, with each process block abutting one or more other process blocks such that the interconnections therebetween are located within the envelope of those process blocks. The process blocks can be positioned end-to-end and/or side-to-side and/or above-below one another. Contemplated facilities include those arranged in a matrix of x by y blocks, in which x is at least 2 and y is at least 3. As another example, in other embodiments, the inputs and outputs of at least some of the 3^{rd} Gen process blocks may be coupled via an internal piping spine that runs through at least a portion of the processing facility (and particularly through (e.g., internally within) the corresponding process blocks). The utility lines associated with the 3^{rd} Gen process blocks may also route along the piping spine so as to feed each of the process blocks. In these embodiments (as well as in other embodiments) the E+I lines and the fluid lines interconnecting the equipment within each process block are not routed through the piping spine and are instead routed independently of the piping spine within the process block (i.e., within the area defined by the corresponding process block).

Within each process block, the modules can also be arranged in any suitable manner. Often times the arrangement of the modules may depend on the transportation constraints for that specific location. Typically, since modules are likely much longer than they are wide (in some embodiments), preferred process blocks have 3 or 4 modules arranged in a side-by-side fashion, and abutted at one or both of their collective ends by the sides of one or more other modules. Individual process blocks can certainly have different numbers of modules, and for example, a first process block may have five (5) modules, another process block may have two (2) modules, and a third process block may have another two (2) modules. In other embodiments, a first process block may have at least five (5) modules, another process block may have at least another five (5) modules, and a third process block may have at least another five (5) modules. Generally, all modules within a process block may abut next to a module within that process block, either horizontally or vertically.

In some embodiments, 3^{rd} Gen Modular Construction facilities are those in which the process blocks collectively include equipment configured to extract oil from oil sands or equipment configured to produce ethylene and/or polypropylene from ethane. Facilities are also contemplated in which at least one of the process blocks produces power used by at least another one of the process blocks, and independently wherein at least one of the process blocks produces steam used by at least another one of the process blocks, and independently wherein at least one of the process blocks includes an at least two story cooling tower. It is also contemplated that at least one of the process blocks includes a personnel control area, which is controllably coupled to the equipment within the at least one process block (e.g., via electrical conductors, fiber optics cables, etc.). In general, but not necessarily in all cases, the process blocks of a 3^{rd} Gen Modular facility may collectively include at least one of a vessel, a compressor, a heat exchanger, a pump, and/or a filter.

Although a 3^{rd} Gen Modular facility might have one or more piperacks to interconnect modules within a process block, it is not necessary to do so. Thus, it is contemplated that a modular building system could comprise A, B, and C modules juxtaposed in a side-to-side fashion, each of the modules having (i) a height greater than 4 meters and a width greater than 4 meters, and (ii) at least one open side; and a first fluid line coupling the A and B modules; a second fluid line coupling the B and C modules; and wherein the first and second fluid lines do not pass through a common interconnecting piperack.

In some embodiments, the modular building system would further comprise a first command line coupling the A and B modules; a second command line coupling the B and C modules; and wherein the first and second command lines do not pass through the common piperack. In more preferred embodiments, the A, B, and C modules may comprise at least, 5, at least 8, at least 12, or at least 15 modules. Preferably, at least two of the A, B and C process blocks may be fluidly coupled by no more than five fluid lines, excluding utility lines. In still other preferred embodiments, a D module could be stacked upon the C module, and a third fluid line could directly couple C and D modules.

Methods of laying out a 2^{nd} Gen Modular facility are different in many respects from those used for laying out a 3^{rd} Gen Modular facility. Whereas the former generally merely involves dividing up equipment for a given process or unit operation among various modules (e.g., an equipment-based approach), the latter preferably takes place in a (process-based) five-step process as described below.

For example, in a typical 2^{nd} Gen Modular facility, equipment is grouped and arranged by type (e.g., pumps for servicing various different processes are arranged within one or more pumping modules and lines connecting the pumps to the various other pieces of equipment related to the various processes and process blocks are routed through one or more external piperacks). While traditional 2^{nd} Gen Modular Construction can be used to prefabricate (prefab) about 50-60% of a complex, multi-process facility; 3^{rd} Gen Modular Construction can be used to prefab up to about 90-95% of the facility. 3^{rd} Gen modular construction can also reduce interconnecting piping and/or cabling, (for example, due to the more direct nature of the interconnections and/or the reduced number of inputs/outputs for each process block) as well as reducing time in the field needed to interconnect modules. The reduction in the length/amount of piping and/or cabling (lines) may result in lower total installed costs (TIC) and/or lower operating hydraulic power demand (with respect to piping) and/or lower operating power demand (with respect to electrical cabling).

Furthermore, the process-based nature of 3^{rd} Gen may allow for much more substantial pre-commissioning, check-out, and/or commissioning (for example at the fabrication or module yard, at a location/site away (e.g., remote) from the ultimate site of the facility—e.g., off-site), thereby reducing effort and time in the field to complete any additional pre-commissioning, check-out, and/or commissioning of process blocks and their systems. By way of example, each process block of a facility might be fully pre-commissioned, checked-out, and/or commissioned off-site, such that the only pre-commissioning, check-out, and/or commissioning left for the field would be interconnections between process blocks and/or the process facility as a whole. So for example, each process block of a 3^{rd} Gen facility (e.g., a 3^{rd} Gen Cracker Facility) might be fully pre-commissioned, checked-out, and/or commissioned off-site (e.g., remotely) with respect to E+I (due to each process block having its own integral/independent/stand-alone E+I system), such that the only E+I pre-commissioning, check-out, and/or commissioning left for the field might be E+I interconnections between process blocks and/or the process facility as a whole (e.g., to ensure that the facility as a whole is up and running properly with respect to E+I once the entire 3^{rd} Gen facility is complete (e.g., with all or substantially all of the process blocks interconnected)). In such embodiments, E+I pre-commissioning, check-out, and/or commissioning could take place at a site remote from the ultimate site of the completed facility and/or without interconnection with any other process blocks and/or modules and/or equipment (e.g., outside of the process block at issue) (for example, with no other process blocks present at that remote site). This also might mean that different process blocks may be constructed as different remote sites, providing efficiency with respect to scheduling and/or resource allocation.

Also, in at least some embodiments, each process block in a 3^{rd} Gen process facility disclosed herein includes its own independent (e.g., self-supporting) power and control (i.e., E+I) systems such that the various process blocks in the 3^{rd} Gen facility do not share E+I systems. As a result, each process block may be independently installed and operated without needing to install other process blocks making up the processing facility. In addition, the independent E+I systems for each process block allow for the avoidance of routing E+I lines through an external piperack extending through the processing facility. Typically speaking, in a 2^{nd} Gen facility, a single E+I system is shared and distributed among all modules such that a relatively large amount of E+I lines (e.g., cabling) must be routed between the control station, room, etc. and the various pieces of equipment within each module. Thus, such a typical 2^{nd} Gen arrangement typically requires running the shared E+I lines through one or more external piperacks extending throughout the facility, which is distinct from 3^{rd} Gen modules.

FIG. 1 is a flow chart 100 showing steps in production of a 3rd Generation Construction process facility. Step 101 is to identify the 3^{rd} Gen Construction process facility configuration using process blocks. In this step, the process lead typically separates the facilities into process “blocks”. This is best accomplished by developing a process block flow diagram. Each process block contains a distinct set of process systems. A process block will have one or more feed streams and one or more product streams. The process block will process the feed into different products as shown herein.

Step 102 is to allocate a plot space for each 3^{rd} Gen Construction process block. The plot space allocation can rely on a piping layout specialist to distribute the relevant equipment within each 3^{rd} Gen Construction process block. At this phase of the project, estimated sizes and weights of equipment may be used to prepare each “block”. A 3^{rd} Gen Construction process block equipment layout requires attention to location to ensure effective integration with piping, and electrical and control distributions. In order to provide guidance to the piping layout specialist, the following steps can be followed:

Step 102A is to obtain necessary equipment types, sizes and weights. It is important that equipment be sized so that it can fit onto a module. Any equipment that has been sized and that cannot fit onto a module envelope may need to be evaluated by a process lead for possible resizing for module installation.

Step 102B is to establish an overall footprint or geometric area for the process block using a combination of transportable module dimensions. A first and second level of the process block may be identified using a grid layout where the grid identifies each module boundary within the process block.

Step 102C is to allocate space for the electrical and control distribution panels on the first level. FIG. 2 is an example of a 3^{rd} Gen Construction process block first level grid 200 (“grid 200”) including various types of equipment. As shown, grid 200 includes modules 202, 204, 206, 208, and 210. The dotted lines between modules indicate module boundaries and indicate envelopes of each module for internal connections. Module 202 may include pumps 212 and power and control distribution 214. Module 204 may include pumps 215 and heat exchangers 216. Module 206 may include horizontal vessel 217. Module 208 may include horizontal vessel 218 and vertical vessel 220. Module 210 includes heat exchangers 222, pumps 224, and vertical vessels 226. Power and control distribution 214 may include E+I panels that are sized to include motor control centers and distributed instrument controllers and inputs/outputs (I/O) necessary to energize and control the equipment, instrumentation, lighting and electrical heat tracing within the process block. The module which contains the E+I panels is a designated 3^{rd} Gen primary process block module.

Step 102D is to group the equipment and instruments by primary systems using process block process flow diagrams (PFDs).

Step 102E is to lay out each grouping of equipment by system (rather than by equipment type) onto the process block layout assuring that equipment does not cross module boundaries. The layout may focus on keeping the pumps located on the same module grid and level as the E+I distribution panels. This may assist with keeping the electrical power cables together. If it is not practical, a secondary option can include having the pumps or any other motor close to the module with the E+I distribution panels. In addition, equipment should be spaced to assure effective operability, maintainability, and safe access and egress.

The use of OptiPlant and/or Fluor's Optimeyes™ may be an effective tool at this stage of the project to assist with process block layouts.

Step 103 is to prepare a detailed equipment layout within process blocks to produce an integrated 3^{rd} Gen facility. Each process block identified from step 102 is laid out onto a plot space assuring interconnects required between blocks are minimized. The primary interconnects are identified from the process flow block diagram. Traditional (external) interconnecting piperacks may no longer be needed or used. A simple, typical 3^{rd} Gen “block” layout 300 is illustrated in FIG. 3. Layout 300 may include process blocks 302, 304, and 306. Feed 308 may enter the process blocks, as shown. Product 310 may exit a process block (e.g., process block 304 upon completion of feed 308 being processed).

Step 104 is to develop a 3^{rd} Gen Module Configuration Table and power and control distribution plan, which combines process blocks for the overall facility to eliminate traditional interconnecting piperacks and reduce the number of interconnects. A 3^{rd} Gen module configuration table is developed using the above data. Templates can be used, and for example, a 3^{rd} Gen power and control distribution plan can advantageously be prepared using the 3^{rd} Gen power and control distribution architectural template.

Step 105 is to develop a 3^{rd} Gen Modular Construction plan, which includes fully detailed process block modules on an integrated multi-discipline basis. The final step for this phase of a project is to prepare an overall modular 3^{rd} Gen Modular Execution plan, which can be used for setting the baseline to proceed to the next phase. It is contemplated that a 3^{rd} Gen Modular Execution will require a different schedule than traditionally executed modular projects.

Many of the differences between the traditional 1^{st} Generation and 2^{nd} Gen Modular Construction and the 3^{rd} Gen Modular Construction are set forth in Table 1 below, with references to the 3^{rd} Gen Modular Execution Design Guide, which was filed in U.S. Provisional application No. 61/287,956, the entire contents of which being previously incorporated by reference above:

TABLE 1

| | Traditional Truckable Modular | |
|---|---|---|
| Activities | Execution | 3^{rd} Gen Modular Execution |
| Layout & Module | Steps are: | Utilize structured work process to |
| Definition | Develop Plot Plan using equipment | develop plot layout based on |
| | dimensions and Process Flow Diagrams | development of Process Blocks with |
| | (PFDs). Optimize interconnects between | fully integrated equipment, piping, |
| | equipment. | electrical and instrumentation/controls, |
| | Develop module boundaries using Plot Plan | including the following steps: |
| | and Module Transportation Envelope | 1. Identify the 3^{rd} Gen process facility |
| | Develop detailed module layouts and | configuration using process blocks |
| | interconnects between modules and stick- | using PFDs. |
| | built portions of facilities utilizing a network | 2. Allocate plot space for each 3^{rd} Gen |
| | of piperack/sleeperways and misc. | Process Block. |
| | supports | 3. Detailed equipment layout within |
| | Route electrical and controls cabling | Process Blocks using 3^{rd} Gen |
| | through interconnecting racks and misc. | methodology to eliminate traditional |
| | supports to connect various loads and | interconnecting piperack and |
| | instruments with satellite substation and | minimize or reduce interconnects |
| | racks. | within Process Block modules. The |
| | Note: This results in a combination of 1^{st} | layout builds up the Process Block |
| | generation (piperack) and 2^{nd} generation | based on module blocks that conform |
| | (piperack with selected equipment) modules | to the transportation envelope. |
| | that fit the transportation envelope. | 4. Combine Process Blocks for overall |
| | | facility to eliminate traditional |
| | | interconnecting piperacks and reduce |
| | | number of interconnects. |
| | | 5. Develop a 3^{rd} Gen Modular |
| | | Construction plan, which includes |
| | | fully detailed process block modules |
| | | on integrated multi-discipline basis |
| | | Note: This results in an integrated |
| | | overall plot layout fully built up from |
| | | Module blocks that conform to the |
| | | transportation envelope. |
| Piperacks/Sleeperways | Modularized piperacks and sleeperways, | Eliminates the traditional modularized |
| | including cable tray for field installation of | piperacks and sleeperways. |
| | interconnects and home-run cables | Interconnects are integrated into Process |
| | | Block modules for shop installation. |
| Buildings | Multiple standalone pre-engineered and | Buildings are integrated into Process |
| | stick built buildings based on discrete | Block modules. |
| | equipment housing. | |
| Power Distribution | Centralized switchgear and MCC at main | Decentralized MCC & switchgear |
| Architecture | and satellite substations. | integrated into Process Blocks located |
| | Individual home run feeders run from | in Primary Process Block module. |
| | satellite substations to drivers and loads | Feeders to loads are directly from |
| | via interconnecting piperacks. | decentralized MCCs and switchgears |
| | Power cabling installed and terminated at | located in the Process Block without |
| | site. | the need for interconnecting piperack. |
| | | Power distribution cabling is installed |
| | | and terminated in module shop for |
| | | Process Block interconnects with pre- |
| | | terminated cable connectors, or coiled |
| | | at module boundary for site |
| | | interconnection of cross module |
| | | feeders to loads within Process |
| | | Blocks using pre-terminated cable |
| | | connectors. |
| Instrument and | Control cabinets are either centralized in | Control cabinets are decentralized |
| Control Systems | satellite substations or randomly | and integrated into the Primary |
| | distributed throughout process facility. | Process Block module. |
| | Instrument locations are fallout of piping | Close coupling of instruments to |
| | and mechanical layout. | locate all instruments for a system on |
| | Vast majority of instrument cabling and | a single Process Block module to |
| | termination is done in field for multiple | maximum extent practical. |
| | cross module boundaries and stick-built | Instrumentation cabling installed and |
| | portions via cable tray or misc. supports | terminated in module shop. |
| | installed on interconnecting piperacks. | Process Block module interconnects |
| | | pre-installed cabling pre-coiled at |
| | | module boundary for site connection |
| | | using pre-terminated cable |
| | | connectors. |

A typical 3^{rd} Gen modular processing facility/system may include at least 3 (typically modular, such as being formed of one or more transportable modules) process blocks (although other embodiments may comprise at least 2, at least 5, at least 7, or at least 10 process blocks). The at least 3 process blocks typically may be non-identical process blocks (e.g., each process block configured for a different process and/or having different structure and/or equipment and/or layout). In this way, 3^{rd} Gen modular construction may be quite different from typical 2^{nd} Gen construction approaches, since the 3^{rd} Gen facility typically may not simply be multiple, substantially identical modules, for example, in parallel (as may be typical of 2^{nd} Gen modular construction, for example).

Typically, the at least 3 process blocks of an exemplary 3^{rd} Gen facility may each comprise one or more transportable modules (which typically would be configured to jointly achieve the process of the corresponding process block, if the corresponding process block is made up of multiple modules). A 3^{rd} Gen modular facility may employ a different layout (of modular elements) than conventional 2^{nd} Gen facilities. For example, the at least 3 process blocks of an exemplary 3^{rd} Gen modular facility may not be laid out on an (external) piperack backbone for interconnecting process blocks (or modules). In other words, in at least some embodiments there typically would be no external interconnecting piperack between/linking/interconnecting the at least 3 process blocks of such a 3^{rd} Gen facility (for at least the process blocks associated with the primary process fluid flow through the production facility). Instead, the 3^{rd} Gen process blocks may be adjacent to one another and directly interconnected (for example, without intervening external piperack or other equipment therebetween). This may mean that in some 3^{rd} Gen embodiments, for example, the interconnections between process blocks would be disposed entirely within an envelope of the process blocks. Thus, interconnections between a first and a second of the at least 3 process blocks of an exemplary 3^{rd} Gen modular facility may be located entirely within the envelopes of the first and second process blocks. Oftentimes, such process blocks may be coupled to minimize interconnects and/or to reduce overall footprint of the facility (for example, with interconnecting process blocks abutting one another). While there may not be interconnecting external piperack(s) in typical 3^{rd} Gen modular construction, each of the process blocks may comprise integral pipeways for fluid/electrical/optical (e.g., fiber optics) distribution within the process block (and in some instances for process block interconnects).

Typically, each of the at least 3 process blocks of a 3^{rd} Gen facility may be configured based on a process-based approach or layout. For example, each process block can be configured to achieve a specific stand-alone process, which may be operable to run without accessing equipment from other modules outside the process block (e.g., other than inputs and outputs from the process block as a whole—such that a process block merely takes its inputs, for example, from one or more other process blocks, performs an integral process or unit operation using those inputs, and then provides or emits the outputs from the integral process (for example, to one or more other process blocks). Each process block typically accepts specific feed(s) and processes such feed(s) into one or more products (e.g., outputs). In some instances, one or more of the feed(s) for a specific process block may be provided from other process blocks(s) (e.g., the products from one or more other interconnected process blocks) in the facility, and in some instances, the products from a specific process block may serve as inputs or feeds into one or more other process blocks of a facility. In the hydrocarbon and chemical business, a process block can comprise equipment, such as processing columns, reactors, vessels, drums, tanks, filters, as well as pumps or compressors to move the fluids through the processing equipment and heat exchangers and heaters for heat transfer to or from the fluids. A process block may include a series of piping systems and controls to interconnect the equipment within the block. By eliminating the traditional interconnecting piperack (e.g., an external piperack), the 3rd Gen approach may facilitate an efficient systems-based layout resulting in the reduction of piping quantities. For solid material processing facilities, such as mineral processing, the piping systems described above may be replaced with material handling equipment (e.g., conveyors, belts, etc.). A process block may include between about 20 to 30 pieces of equipment, but there could be more or less equipment in some process block embodiments. Typically, all equipment for a specific process would be located within a single (for example, contiguous) footprint or geographic area and/or envelope. Thus, the inputs/feeds for a specific process block would typically be the inputs needed for the process (as a whole), and the outputs for the process block would typically be the outputs resulting from the process (as a whole). Thus, the actual process would basically be self-contained (physically) within the corresponding process block. This may differ from conventional 2^{nd} Gen approaches, which may use an equipment-based approach (such that 2^{nd} Gen modules may be required to interact with equipment from several modules being needed to perform a specific process). In other words, 3^{rd} Gen process block embodiments may not have an equipment-based approach or layout.

In at least some embodiments of a 3^{rd} Gen modular processing facility, each process block includes multiple pieces and types of equipment for carrying out one or more unit operations within the contiguous area or region defined by the process block. The unit operations and associated equipment may be arranged to carry out, or relate to one or more common, overarching processes within the 3^{rd} Gen modular processing facility.

In at least some of these embodiments, the equipment disposed within the process block may be grouped by type within a given process block. For example, within a given process block, each of the units or pieces of equipment of one type (e.g., each of the pumps within the process block) may be disposed together within a first defined envelope or space within the overall boundary of the process block and each of the units or pieces of equipment of another type (e.g., each of the heat exchangers within the process block) may be disposed together within a second defined envelope or space within the overall boundary of the process block. Within this example, the first defined region may be separate (e.g., not overlapping) with the second defined region with the given process block. In some embodiments, such grouping of a specific type of equipment may only occur for one type of equipment within the process block (such as E+I equipment, which may all be grouped or located together within a process block), or it may occur for multiple (or even all) types of equipment within the process block.

In a typical exemplary 3^{rd} Gen modular processing facility, each of the at least 3 process blocks may comprise its own integral E+I system and distribution (e.g., electrical control and instrument system). As a result, each process block in a 3^{rd} Gen modular processing facility disclosed herein may include its own integral (e.g., self-supporting) power supply and/or distribution and control systems for operating that process block (and the equipment disposed therein). This may eliminate home run interconnecting cabling through traditional interconnecting racks (of the sort which may be used in conventional 2^{nd} Gen modular approaches). In addition, this may be beneficial for allowing each process block to operate as a stand-alone process (as described above, for example), and may provide commissioning benefits (for example, as discussed above). So, for example, each of the at least 3 process blocks may be configured to allow for independent pre-commissioning, check-out, and/or commissioning of its corresponding process system and/or E+I (for example, without connection to any other of the at least 3 process blocks). This may allow for separate/independent pre-commissioning, check-out, and/or commissioning of its corresponding process system and/or E+I, for example, at a location separate and apart (e.g., geographically distant) from the ultimate site of the facility (such as a fabrication facility or module yard). The ability to perform separate/independent pre-commissioning, check-out, and/or commissioning for each 3^{rd} Gen process block may be due to integral E+I within each process block, the process block design approach, and/or lack of external interconnecting piperack, which, for example, may allow for fewer connections which can be more easily connected for simulation and/or testing. Moreover, because of the independent, integral E+I system and distribution within each process block, as each process block can be installed at the production facility, it may be independently operated for its intended function or process while other process blocks are either not yet operational or are not yet even installed (assuming that the operating process block's feed is available and other necessary utility services to the operating process block have been connected and are operating). Such independent operation of process blocks was not available in a 2^{nd} Gen production facility since operation of any one process required the installation of the shared E+I system and distribution to the entire production facility. As a result, the total time to production from a 3^{rd} Gen production facility may be greatly shortened from that typically experienced in a 2^{nd} Gen production facility.

The arrangement/layout of process blocks in exemplary 3^{rd} Gen modular facilities may also be distinct. For example, each of the at least 3 process blocks may be located/arranged in proximity to one or more other of the at least 3 process blocks (e.g., without intervening process blocks, modules, and/or piperacks therebetween). Typically, each of the at least 3 process blocks may be interconnected to one or more other of the at least 3 process blocks (and, for example, the interconnects might include fluid (e.g., piping), solids (e.g., conveyors), etc.). Typically, each of the at least 3 process blocks would be positioned/arranged in proximity to the other of the at least 3 process blocks to which it directly interconnects, for example, without intervening external piperacks and/or process blocks therebetween. While not required in all 3^{rd} Gen embodiments, often the at least 3 process blocks would abut at least one other of the at least 3 process blocks (for example, interconnected process blocks might typically abut one another—for example, forming a contiguous geographic footprint and/or envelope). For such abutting process blocks, interconnections between such process blocks might typically be disposed entirely within the envelope (internal lines) of abutting process blocks. And in some 3^{rd} Gen embodiments, all process blocks may abut the other process blocks to which they interconnect (or at least might directly abut the other process blocks with which it interacts with respect to the primary process flow), such that the facility as a whole may have a contiguous geographic footprint and/or envelope (in which case, all interconnections between process blocks might be within the contiguous envelope of the facility process blocks as a whole (e.g., jointly), such that no external piperacks would be necessary).

The process blocks may each have feed input piping (or solid material transfer), product output piping (or solid material transfer), and utility support inputs and outputs. Utility support inputs and outputs may include one or more inputs for fluid lines (e.g., pipes, conduits, hoses, etc.) that carry fluids (e.g., liquids and/or gases) to support the systems operation within a process block. For example, such liquids and gases carried by the utility pipes include, steam, water, N₂, O₂, air, etc. Process blocks may be arranged to efficiently interconnect to each other based on the process flow through the facility. Utilities may also be interconnected between process blocks in a similar design for efficient flow.

Each process block may be formed of one or more transportable modules (thereby allowing construction of such modules off-site at locations distant from the final site for the process facility). Each of the transportable modules for the process blocks may be sized, as discussed above, with respect to transportable modules. And in some embodiments, one or more of the modules may be sized to be truckable, as described above. So, a process block can be formed of (e.g., comprise) one to several modules, for example, depending on the maximum module size and/or weight the local site infrastructure will allow for transport. The use of smaller truckable modules might result in several modules per process block, while the use of VLMs (very large modules) may allow for one module per process block. The modules making up each process block may be configured with equipment so that, when interconnected, the modules may jointly perform the process of the corresponding process block (for example, with the equipment in a plurality of related modules for a corresponding process block working together (e.g., interlinked) to accomplish the overall process of the process block). In laying out modules (in forming a corresponding process block), each module may be arranged in proximity (abutting) with the one or more modules with which it interconnects (e.g., without any intervening external piperack and/or module). So typically, the modules for a process block may not interconnect via an external piperack (a piperack located external to the modules), but may rather be directly connected internally via an envelope of each module. The modules associated with a specific (corresponding) process block may abut to form a contiguous footprint and/or envelope for the process block as a whole. As otherwise described herein, such abutment of modules and/or process blocks may be side-by-side, end-to-end, and/or stacked, for example.

Such 3^{rd} Gen modular process facilities may be constructed uniquely, due to the 3^{rd} Gen nature of the process blocks and/or modules and/or the process-based approach. For example, a typical exemplary 3^{rd} Gen modular method of constructing a processing facility (for example, of the sort described above) might comprise arranging a plurality of process blocks (e.g., at least 3 process blocks) with respect to one another, wherein the at least 3 process blocks are non-identical process blocks (e.g., each configured for a different process) (e.g., not simply multiple, substantially identical modules, for example in parallel), wherein the at least 3 process blocks each comprise one or more transportable modules (which are configured to jointly achieve the process of the corresponding process block); and wherein the at least 3 process blocks are not laid out on an external piperack backbone for interconnecting process blocks (or modules) (e.g., no external interconnecting piperack between/linking/interconnecting the 3 process blocks) (e.g., process blocks are directly interconnected (without intervening piperack therebetween, for example, such that the interconnections between process blocks are disposed entirely within an envelope of the process blocks—for example, with interconnections between a first and a second of the at least 3 process blocks being located entirely within the envelopes of the first and second process blocks)). Such a method might also and/or further comprise constructing one or more (e.g., each or all) of the at least 3 process blocks at one or more location different (remote/away) from the ultimate site of the processing facility (e.g., a fab or mod yard); and pre-commissioning, check-out, and/or commissioning of a corresponding process system for the one or more process blocks constructed away from the ultimate facility site (e.g., at the fabrication site or module yard) (e.g., without connection to any other of the at least 3 process blocks—instead using an input stream source, e.g., emulating the output stream from the process module which is to be interconnected) (e.g., at a location separate and apart from the ultimate site of the facility, such as a module yard) (e.g., due to integral E+I, process block design approach, and/or lack of external interconnecting piperack). In some embodiments, such methods may further comprise directly interconnecting (e.g., without an external interconnecting piperack) each process block (which might be pre-commissioned, checked out, or commissioned previously) to one or more adjacent process blocks (e.g., without intervening external piperacks and/or other process blocks therebetween). In some such methods, the arrangement of process blocks may also include close coupling one or more (e.g., all) of the at least 3 process blocks (e.g., to reduce overall footprint of the facility and/or reduce/minimize interconnects). Some method embodiments may further comprise designing/configuring each process block to accomplish a corresponding process, which in some embodiments may include laying out equipment in the modules making up each process block accordingly. Also, some method embodiments may further comprise the step of providing integral E+I distribution for each of the at least 3 process blocks (e.g., to eliminate home run interconnecting cabling). The modular nature of 3^{rd} Gen construction may also allow for more efficient construction and/or implementation, for example, using integrated execution to support the modular implementation with reduced scheduling versus traditional/conventional stick build or 2^{nd} Gen (e.g., equipment only modules).

In some embodiments, two or more of the process blocks to be interconnected may not be able to be placed adjacent to one another such that one or more fluid lines interconnecting the inputs and outputs of the two or more process blocks may be routed through an intervening process block or other equipment. In at least some embodiments, such a routing of the one or more fluid lines does not occur. Design efforts (regarding placement of process blocks and/or interconnections between process blocks) may seek to minimize this type of indirect routing or interconnection as much as possible (e.g., most process blocks should preferably be directly interconnected and located adjacent to the other process blocks with which it interacts, especially with respect to the primary process flow). So for at least some embodiments, the primary flow (i.e., the primary process flow through the 3^{rd} Gen production facility) may flow between adjacent and directly interconnected process blocks. Stated another way, the process blocks in a 3^{rd} Gen production facility that are associated with the main or primary process flow are typically positioned adjacent one another such that each of these process blocks is directly interconnected with no intervening piperacks or other equipment or modules therebetween. So while there may be process blocks in a 3^{rd} Gen facility that are not adjacent and/or interconnected with one or more other process blocks with which it interacts, in a 3^{rd} Gen facility typically at least 3, at least 5, at least 8, or at least 10 process blocks (for example, relating to the main or primary process flow) would be adjacent (or abutting) and/or directly interconnected with the other such of the at least 3, at least 5, at least 9 or at least 10 process blocks with which it interacts.

In addition, in some embodiments, one or more of the fluid lines interconnecting the inputs and outputs of the 3^{rd} Gen process blocks are routed through a central piping spine that runs through at least a portion of the (and in some instances, through the entire) processing facility (and particularly through at least some of the process blocks, with the spine located internally within at least some of the process blocks). In addition, in at least some of these embodiments, the utility lines (e.g., carrying steam, water, air, N₂, O₂, etc.) associated with the process blocks may also route along the piping spine so as to access each of the process blocks. In these embodiments (as well as in other embodiments) the E+I lines and the fluid lines interconnecting the equipment within each process block are not routed through the piping spine and are instead routed within each individual process block (i.e., within the geographic area defined by the corresponding process block) as described above. Such an optional spine might serve to line up inputs and outputs for multiple process blocks (for example regarding the primary process flow and/or utilities), thereby optimizing layout of a facility. So, typically such a spine would not be used for equipment connections within process blocks, but would instead typically be focused on inputs and outputs between interconnected process blocks.

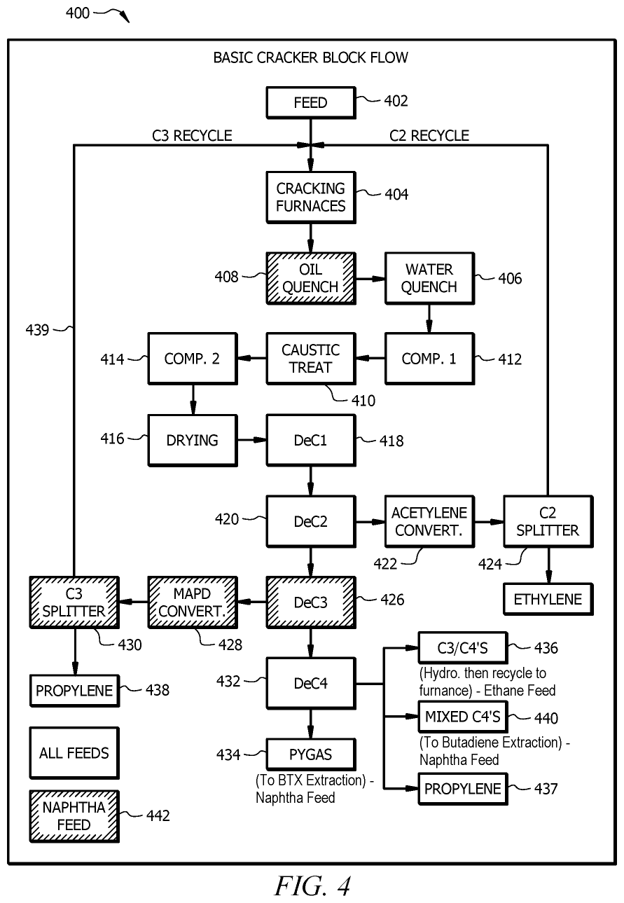

While 3^{rd} Gen modular construction may be used for any number of different types of process facilities, one specific example would be a (steam) ethylene cracker application (e.g., for processing an ethane feed into ethylene (and possibly additional output streams)) as discussed below with respect to FIGS. 4-7.

The modular construction techniques described herein can be used for a variety of processes including cracker processes. FIG. 4 is a schematic of an exemplary cracker process block flow diagram 400. Typically, a compact modular steam cracker production facility may produce ethylene (and additionally propylene) from an ethane feed stream 402. Generally, in a steam cracker, gaseous or light liquid hydrocarbons may be heated to approximately 750-950 degrees Celsius (for example, using furnace(s) 404 where steam may be introduced to the process). The outlet stream from furnace 404 may be cooled with quench water 406, and, in the case of producing propylene, the outlet stream may be quenched with oil 408. Quenching the outlet stream from furnace 404 may form cracked gas which may be caustic scrubbed and compressed.

Generally, the caustic treatment towers 410 may be located between compressor stages (compressors 412 and 414) as shown in FIG. 4, where carbon dioxide and hydrogen sulfide may be removed in stages. Once washed (e.g., caustic treatment/caustic wash/caustic scrubbing) and compressed, the output (e.g., overhead stream from the quench tower) may be dried in dryer 416 and cryogenically treated. Generally, the cold cracked gas may go to the demethanizer tower 418, and the bottoms stream from the demethanizer tower 418 may flow to the deethanizer tower 420. Generally, the overhead stream from the deethanizer tower 420 may be sent to the acetylene converter 422 where acetylene may be converted to ethylene and ethane. Typically, the ethylene and the ethane may flow to a C₂ splitter 424 where the ethylene and the ethane may be fractionated. The ethane may be recycled to the steam cracking furnaces (e.g., furnaces 404) and mixed with the fresh feed. Additionally, the bottom stream from the deethanizer tower 420 may go to the depropanizer tower 426. The overhead stream from the depropanizer tower 426 may be hydrogenated and sent to methylacetylene and propadiene (MAPD) converter 428 and C₃ splitter 430. The propylene product 438 may be produced via the overhead stream, and the bottoms stream may contain propane which may be sent back to the furnace 404 via line 439. Additionally, as shown in FIG. 4, to produce Pygas (light pyrolysis gasoline) product 434, the bottom stream from the depropanizer tower (e.g., DeC₃) 426 may be fed to the debutanizer (e.g., DeC₄) tower 432. In FIG. 4, the debutanizer tower 432 may produce Pygas 434 in the bottoms stream and the other streams may consist of propane and/or butane 436, propylene 437, mixed C₄ (butane and/or butadiene), which may be hydrogenated and recycled or sent to butadiene extraction (e.g., naphtha feed 442).

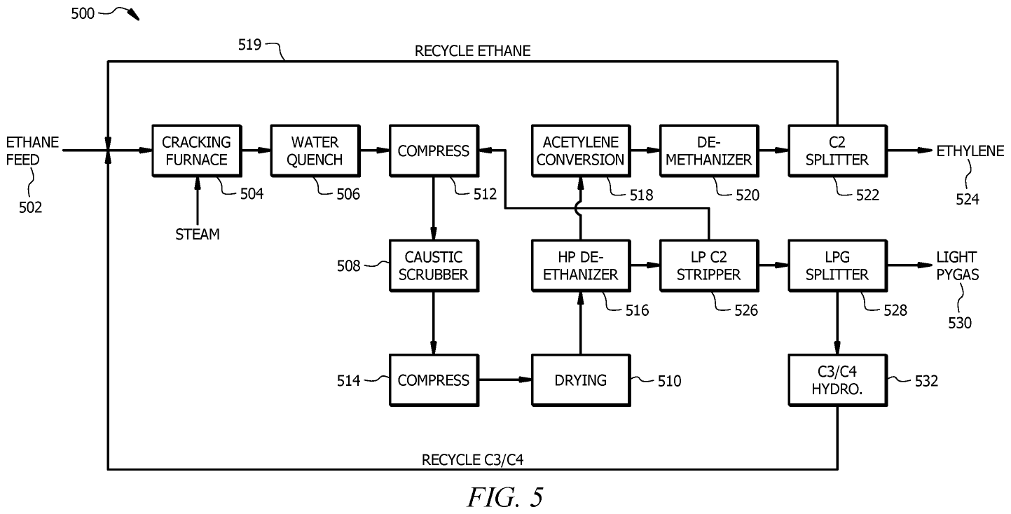

Having described the production of ethylene, pygas, and propylene in FIG. 4, FIG. 5 illustrates an alternative (more simplified) schematic of an exemplary cracker block flow diagram to produce ethylene and pygas (similar to FIG. 4, but without the additional output streams—for example propylene). Generally, the process to produce ethylene and pygas may be similar to the process described above. Additionally, the equipment used in the process blocks may be similar. However, as can be seen in FIG. 5, the layout of the process blocks may be rearranged to produce the same products: ethylene and pygas. In the exemplary process block flow diagram 500, ethane may serve as the feed stream 502. Generally, in a steam cracker, gaseous or light liquid hydrocarbons may be heated to approximately 750-950 degrees Celsius (for example, using cracking furnace 504 where steam may be introduced to the process). The outlet stream from the cracking furnace 504 may be cooled with a water quench process 506. Once cooled, the outlet stream from the water quench 506 may be compressed and caustic scrubbed (e.g., via the caustic scrubber 508). The outlet stream from the caustic scrubber 508 may further be compressed and dried in dryer 510 (so that typically the caustic scrubber stage is located between/interacts with two compressor stages 512, 514 (which in some embodiments may both take place within a single compression process block)). Generally, the cold cracked gas may go to a deethanizer tower 516 (e.g., high pressure (HP) deethanizer tower). The overhead stream from the deethanizer tower 516 may be sent to the acetylene converter 518 where acetylene may be converted to ethylene and ethane. The outlet from the acetylene converter 518 may be sent to a demethanizer 520 to separate ethylene from lighter components. In some embodiments, the demethanizer 520 may consist of separation through distillation, and may produce methane and hydrogen as side products of this process. The outlet stream from the demethanizer 520 may be fractionated in the C₂ splitter 522 (e.g., the ethane stream may be recycled back to the beginning of the process via line 519, the ethylene stream 524 may be collected as a product).

In the exemplary embodiment of FIG. 5, the deethanizer tower 516 (e.g., HP deethanizer) may comprise a bottoms stream. Typically, the bottoms stream may be sent to an LP (low pressure) C₂ stripper 526 where the overhead stream may be sent to the first compressor 512 (e.g., located before the caustic scrubber), and the bottoms stream may be sent to a liquefied petroleum gas (LPG) Splitter 528. Generally, the LPG Splitter 528 may separate the light Pygas 530 from the heavier components 532 (e.g., propane, propylene, butane, and/or butadiene (which may be hydrogenated and recycled or sent to butadiene extraction (e.g., naphtha feed))). In this manner, the cracker block flow diagram illustrated in FIG. 5 may produce ethylene and light pygas. Typically, in 3^{rd} Gen cracker facilities similar to FIGS. 4 and 5, each such stage/process step might be a separate process block (although in some embodiments, two or more such stages/process steps could be combined within a single process block).

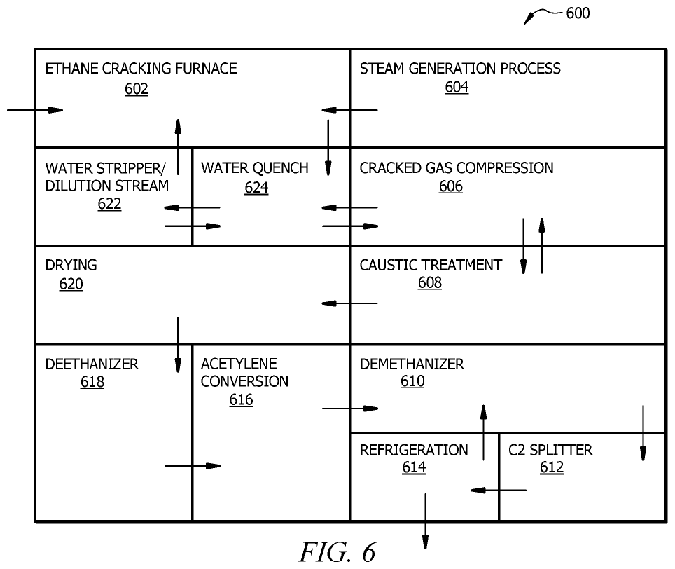

FIG. 6 illustrates a schematic of an exemplary process blocks layout 600 in an exemplary ethylene cracker facility showing general input and output flows (depicted by arrows) for each process block 602, 604, 606, 608, 610, 612, 614, 616, 618, 620, 622, and 624. In the exemplary process blocks layout 600 shown in FIG. 6, the sizing/scale of each process block may not be accurate—this schematic is merely intended to illustrate relative location and/or interconnection between process blocks. Additionally, the locations of the process blocks may be changed to achieve a similar perhaps more efficient layout. In other words, in some cases, two or more of the process blocks to be interconnected may not be placed adjacent one another such that one or more fluid lines interconnecting the inputs and the outputs of the two or more process blocks must be routed through another intervening process block or equipment. Generally, this sort of arrangement may not be needed. If such routing of the fluid lines becomes necessary, design efforts (regarding placement of process block and/or interconnections between process blocks) would typically seek to minimize this type of indirect routing or interconnection as much as possible. Preferably, the process blocks should directly interconnect and be located (e.g., side-to-side) adjacent to the other process block with which it interacts as shown in the exemplary process block layout in FIG. 6.

In FIG. 6, the ethane cracking furnace process block 602 is located (side-to-side) adjacent to the steam generation process block 604, the water stripper/dilution stream process block 622, and water quench process block 624. Typically, the steam generation process block 604 may provide steam to the ethane cracking furnace block 602 and may be steam coupled to the ethane cracking furnace(s) process block 602. Additionally, the output from the ethane cracking furnace process block 602 may be sent to the water quench process block 624 (typically located (side-to-side) adjacent to the ethane cracking furnace process block 602, the water stripper/dilution stream process block 622, and the cracked gas compression process block 606, and often also (side-to-side) adjacent to the drying process block) as described in reference to FIGS. 4 and 5 to cool the output stream. The water stripper/dilution stream process block 622 (typically (side-to-side) adjacent to the water quench process block 624 and the ethane cracking furnace process block 602, and often also (side-to-side) adjacent to the drying process block 620) may interact with the water quench process block 624, and the dilution stream process block 622 may interact with the ethane cracking furnace process block 602. Once the output from the ethane cracking furnace process block 602 is cooled by the water quench process block 624, the output may be sent to the cracked gas compression process block 606 (which is typically (side-to-side) adjacent to the water quench process block 624 and the caustic treatment process block 608, and also the steam generation process block 604) where a series of compressors may compress the cooled fluid before sending it to caustic treatment process block 608 (which is typically located (side-to-side) adjacent to the cracked gas compression process block 606 and the drying process block 620, and is also (side-to-side) adjacent to the demethanizer process block 610). Generally, caustic treatment may occur between a series of compressors (for example, by interacting again with the cracked gas compression process block 606 located (side-to-side) adjacent and discussed above). Therefore, the cracked gas compression process block 606 and the caustic treatment process block (608) may interact with each other (e.g., two-way manner). Typically, the (final—e.g., after all compression interaction with the cracked gas compression process block 606) outlet stream from the caustic treatment process block 608 may be dried in a drying process block 620 (typically located (side-to-side) adjacent to the caustic treatment process block 608 and the deethanizer process block 618, and often also (side-to-side) adjacent to the water stripper/dilution stream process block 622, water quench process block 624, and/or acetylene conversion process block 616). Generally, the cold cracked gas from the drying process block 620 may be sent to the deethanizer process block 618 (which is typically (side-to-side) adjacent to the drying process block 620 and the acetylene conversion process block 616) where the overhead stream from the deethanizer process block 618 (e.g., a deethanizer tower may) be sent to the acetylene conversion process block 616 where acetylene may be converted to ethylene and ethane. The acetylene conversion process block 616 is typically (side-to-side) adjacent to the deethanizer process block 618 and the demethanizer process block 610, and often is also (side-to-side) adjacent to the refrigeration process block 614. The outlet stream from the acetylene conversion process block 616 may be sent to the demethanizer process block 610 (typically located (side-to-side) adjacent to the acetylene conversion process block 616, the refrigeration process block 614, and the C₂ splitter process block 612) to separate ethylene from the lighter components. Typically, the refrigeration process block 614 (which is typically (side-to-side) adjacent to the demethanizer process block 610 and the C₂ splitter process block 612, and often is also (side-to-side) adjacent to the acetylene conversion process block 616) may provide refrigerant to a cold box used in the demethanizer process block 610. The outlet stream from the demethanizer process block 610 may be fractionated in the C₂ splitter process block 612 (which is typically (side-to-side) adjacent to the demethanizer process block 610 and the refrigeration process block 614), and the ethylene may be sent to the refrigeration block 614. FIG. 6 shows such an exemplary process block arrangement/configuration, along with exemplary flow interactions therebetween. In the example of FIG. 6, all process blocks typically are side-by-side adjacent to any other process blocks with which they (directly) interact, for example allowing flow across an adjoining side of the typically substantially rectangular process blocks. It should be noted that any such side-to-side adjacency/abutment can be with any side of the related process blocks, so process blocks could be stacked as well (e.g., the configuration/arrangement may be two-dimensional or three-dimensional, depending on the circumstances such as the geographic footprint available for the facility). While in FIG. 6, the process blocks could be merely adjacent but not contacting, oftentimes two or more of the process blocks actually abut (and as shown in FIG. 6, all process blocks may abut with any adjacent process blocks, such that any use of the term adjacent could also include abutment).

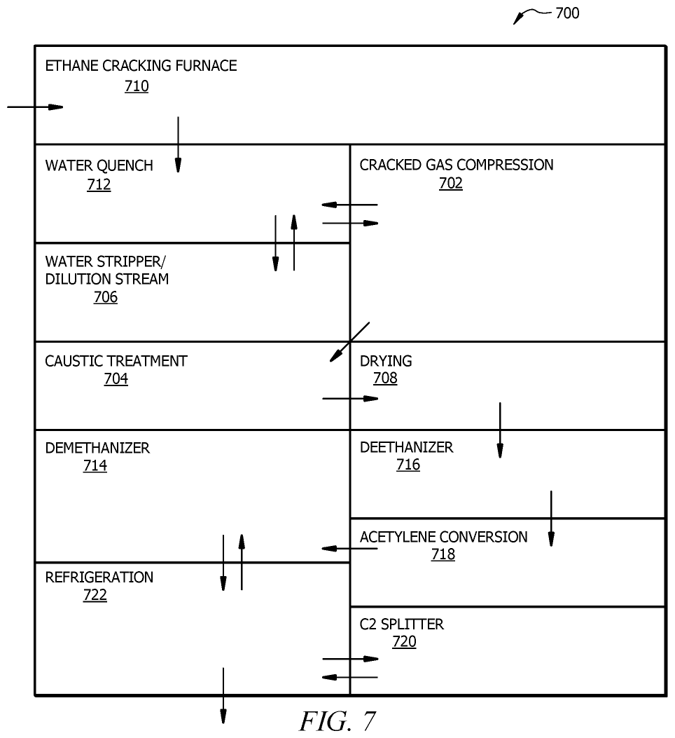

FIG. 7 is an alternative schematic of an exemplary process block layout 700 in an ethylene cracker facility showing general input and output flows (depicted by arrows) for each process block 702, 704, 706, 708, 710, 712, 714, 716, 718, 720, and 722. Generally, the process blocks shown in FIG. 7 may interact in a similar manner to those shown in FIG. 6 (e.g., with flows between process blocks similar to those discussed above with respect to FIG. 6). However, in some cases, the process blocks which interact with each other may not lay directly (e.g., side-by-side) adjacent to one another (for example, perhaps requiring flow across adjacent corners of diagonally adjacent process blocks in some instances). For example, in the exemplary embodiment of FIG. 7, the cracked gas compression process block 702 is shown to interact with the caustic treatment block 704 in a diagonal manner. Typically, this may cause some interaction with the water stripper/dilution stream process block 706 and/or the drying (stream) process block 708 (e.g., there may be some minimal amount of flow through one or more of these additional process blocks to facilitate the diagonal flow pattern between two such diagonally adjacent process blocks, with all such flow typically located within the contiguous footprint of the facility, without any external piperack and/or with all flow interactions located within an envelope of the relevant process blocks, which typically may abut one another). Generally, this may not be a preferred process block layout, but, in some cases, it may be seen to minimize the amount of piping, layout spacing, etc. which may be needed for a cracker facility.

In FIG. 7, the process block arrangement/configuration is as follows: The ethane cracking furnace process block 710 is adjacent (side-to-side) to the water quench process block 712 and the cracked gas compression process block 702; the water quench process block 712 is also adjacent (side-to-side) to the water stripper/dilution stream process block 706 and the cracked gas compression process block 702; the water stripper/dilution stream process block 706 is also adjacent (side-to-side) to the caustic treatment process block 704 and the cracked gas compression process block 702; the cracked gas compression process block 702 is also adjacent (side-to-side) to the drying process block 708 and diagonally (e.g., indirectly) adjacent to the caustic treatment process block 704 (and as discussed above, side-to-side adjacent to the water quench process block 712, water stripper/dilution stream process block 706, and ethane cracking furnace process block 710); the caustic treatment process block 704 (in addition to being side-to-side adjacent to the water stripper/dilution stream process block 706 and diagonally adjacent to the cracked gas compression process block 702) is (side-to-side) adjacent to the drying process block 708 and the demethanizer process block 714; the drying process block 708 is also (side-to-side) adjacent to the deethanizer process block 716 (in addition to the caustic treatment process block 704 and the cracked gas compression process block 702); the deethanizer process block 716 is also (side-to-side) adjacent to the acetylene conversion process block 718 and the demethanizer process block 714; the acetylene conversion process block 718 is also (side-to-side) adjacent to the demethanizer process block 714 and the C₂ splitter process block 720, and typically might also be side-to-side adjacent to the refrigeration process block 722 (for example, with a portion of one side of the acetylene conversion process block 718 being side-to-side adjacent to both the demethanizer process block 714 and the refrigeration process block 722); the refrigeration process block 722 is also (side-to-side) adjacent to the C₂ splitter process block 720 (in addition to being side-to-side adjacent to the demethanizer process block 714 and acetylene conversion process block 718, as discussed above; the C₂ splitter process block 720 is thus (side-to-side) adjacent to the refrigeration process block 722 and acetylene conversion process block 718. The arrows depicted represent input and output flows between process blocks, as shown. The process block configuration/arrangement/layout of the examples shown in FIGS. 6 and 7 is readily apparent from the figures and incorporated herein by way of non-exclusive example. While FIGS. 6 and 7 provide examples of such cracker facility process block arrangements/configurations, persons of skill will appreciate other such layout approaches, including approaches/configurations/arrangements with additional (optional) process blocks (for example, additional process blocks for pygas and/or propylene stages as shown in FIGS. 4 and 5). And while the process blocks in these examples (e.g., FIGS. 6 and 7) may be described as adjacent, often one or more (or typically all) of such adjacent process blocks may actually abut (e.g., directly contact) and/or interact). Furthermore, adjacent (or abutting) process blocks may be either horizontally (e.g., in a horizontal plane) adjacent or abutting (side-to-side, for example with a left side of a first process block abutting a right side of a second process block) or vertically (e.g., stacked, as in a vertical plane) adjacent or abutting (side-to-side, for example with a top side of a first process block abutting a bottom side of a second process block), depending for example on the footprint for the facility. Diagonally adjacent or abutting process blocks might similarly be located in a horizontal plane or diagonal vertically (e.g., not directly stacked, but with the second process block stacked atop or located beneath a third process block that is horizontally adjacent/abutting a first process block).

e.g., And as discussed above, the distributed (e.g., stand-alone/independent) E+I for each process block of a 3^{rd} Gen facility may allow for independent pre-commissioning, check-out, and/or commissioning of that process block (e.g., with respect to E+I). For example, each process block may be pre-commissioned, checked-out, and/or commissioned at a site remote from the ultimate facility site and/or without the need for interconnection to any other process block and/or module and/or equipment. By way of example, one or more of the exemplary pre-commissioning, check-out and/or commissioning steps set forth in Tables 2-5 below may be performed independently for each process block of a 3^{rd} Gen facility (e.g., at a remote site and/or without interconnection with other process blocks, modules, and/or other equipment):

TABLE 2
ELECTRICAL

a. Test and inspect equipment per STD 15-3.02 - “Field Inspection and
Testing”, e.g.; Meggering, Hi-pot, relay calibration functional tests,
transformer testing.
b. Charge electrical gear with oil and/or other media, as required.
c. Perform trials and adjustments on all switchgear, motor control
equipment, and generators per STD Series 15.
d. Test, calibrate, and set switchgear, circuit breakers, and relays for
proper coordination.
e. Coordinate energization of substations with COMPANY Proj. and
COMPANY CSU, after completion of required test.
f. Check phase sequence, polarity, and motor rotation, and other required
tests per STD 15 - 3.02.
g. Check installation of all cabletray, raceways and lighting systems in
accordance with STD 15-3.02.
h. Provide all field data test records in accordance with STD 15-3.02.
i. Pack and pour seals.

TABLE 3
CONTROL SYSTEM LOOP CHECKS

a. Perform non energized loop checks: Connect all system components
and check all electrical signal circuits and alarm wiring for continuity,
correct source of power, and polarity. Check thermocouples for proper
joining of wires, position of elements in wells, proper polarity,
and continuity of receiving instruments.
b. Perform energized loop checks: Temporarily energize to verify
operational configuration, integrity, calibration, and readiness and
verify their conformance to IFC design for function and range using
simulated signals as required.

TABLE 4
INSTRUMENT SYSTEMS

a. Factory Acceptance Tests (FAT) - Hardware
b. Site Acceptance Tests (SAT)
c. Install, test and terminate fiber optic cabling.
d. Perform instrument installation checkout, including wiring, tagging,
tubing, supports, accessibility, insulation, position, and configuration.
e. Conduct any non-operating checks to ensure instrument operability:
check pointer travels; and verify instrument capacity to measure, operate,
and stroke in the direction and manner required by the process application.
f. Check documentation to ensure all instruments have been supplied/
tested/calibrated to the current IFC data sheets. As dictated by
COMPANY, bench or field calibrate revised instruments with standard
test equipment.
g. Clean all transmission and control tubing by blowing with dry, filtered
clean air before connecting to instrument components (Extension of the
clean pipe program).
h. Clean all air-supply headers by blowing with dry, clean air and
check them for tightness.
i. Leak test pneumatic control circuits. Provide test records.
j. Check tubing from instruments to process piping for tightness. Test all
impulse tubing and components, and provide test records.
k. Obtain local inspector's approval, where required.
l. Isolate or remove, if necessary, inline components i.e. severe service
control valves, positive displacement meters, and turbine meter for
pressure testing and “course” flushing. Reinstall these items
after testing.

TABLE 5
INSPECTION

a. Conduct walkdowns of systems/facilities to confirm construction/
mechanical completion, per IFC design and design change documentation.
Prepare and manage a master punchlist of open items, including
responsibility and forecast completion dates.
b. Verify that specified materials have been installed in the plant, or
portions thereof, and document verification to the extent required by the
COMPANY. Note any exceptions on Punch List.
c. Conduct final joint walkdowns of systems/facilties to verify mechanical
completion per IFC design. Maintain and manage a master Punch List of
open items, including responsibility and forecast completion dates.

It should be understood that one or more of these Tables 2-5 steps (e.g., relating to E+I systems pre-commissioning, check-out and/or commissioning) may be performed remotely (e.g., at a site remote from the ultimate facility site) and/or independently (e.g., without interconnection to any other process block, for example) for each process block of a 3^{rd} Gen facility (for example for a 3^{rd} Gen cracker facility of the type described above).

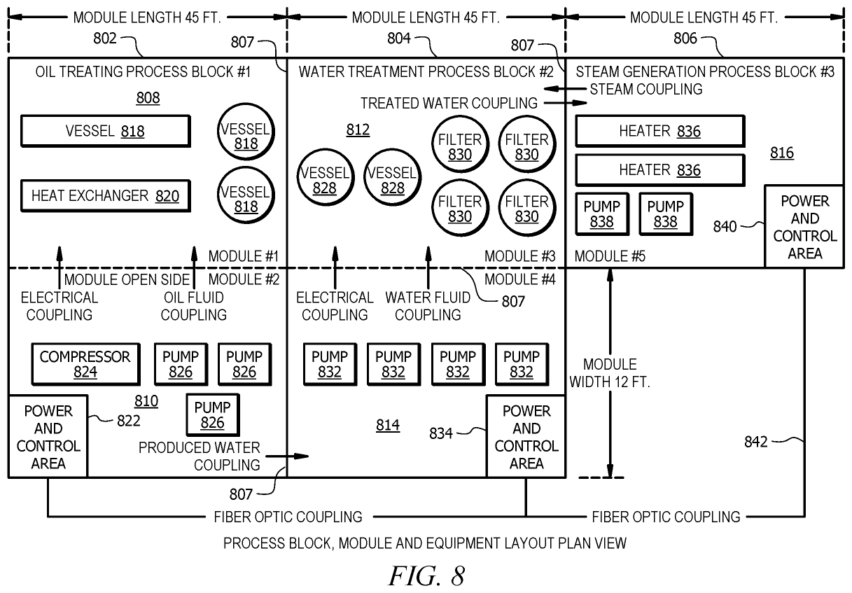

FIG. 8 is a schematic of three exemplary process blocks (802, 804, and 806) in an exemplary oil separation facility designed for the oil sands region of western Canada. As shown, process block 802 has two modules 808 and 810, process block 804 has two modules 812 and 814, and process block 806 has only one module 816. The lines (dotted and solid) between modules indicate open envelopes 807 to allow for internal connections between adjacent modules and/or adjacent process blocks. The arrows between process blocks and/or modules show fluid lines (couplings), electrical lines, and/or control lines (e.g., fiber optics) between modules. Module 808 may include vessels 818 and heat exchanger 820. Module 810 may include power and control area 822, compressor 824, and pumps 826. Module 812 may include vessels 828 and filters 830. Module 814 may include pumps 832 and power control area 834. Module 816 may include heaters 836, pumps 838, and power and control area 840. Thus, FIG. 8 shows only one electrical line connection and one fluid line connection between modules #1 and #2. Similarly, FIG. 8 shows no electrical line connections between process blocks #1 and #2, and only a single fluid line connection between those process blocks. Further, FIG. 8 shows utility lines (shown as “Steam Coupling” and “Treated Water Coupling”) extending between module #3 of Water treatment process Block #2 and module #5 of Steam Generation Process Block #3.

Still further, FIG. 8 shows that each process block (process blocks #1, #2, #3) each have their own Power and Control Area. In at least some embodiments, each Power and Control Area 822, 834, and 840 is a designated location (which in some embodiment comprises an enclosure or room, or simply one or more control panels) within the corresponding process block that operating personnel may direct, monitor, initiate, and/or control (collectively “control operations”) the operation of the process block and any and all equipment contained therein. Typically, the integrated E+I system and distribution is coupled to and includes the Power and Control area to facilitate the control operations described above. Also, control lines such as fiber optic coupling 842 may extend between each of the Power and Control Areas 822, 834, and 840. It should be appreciated that such a coupling is not required and may not be included in other embodiments (i.e., in some embodiments, the Power and Control Areas of each process block are not coupled to one another).

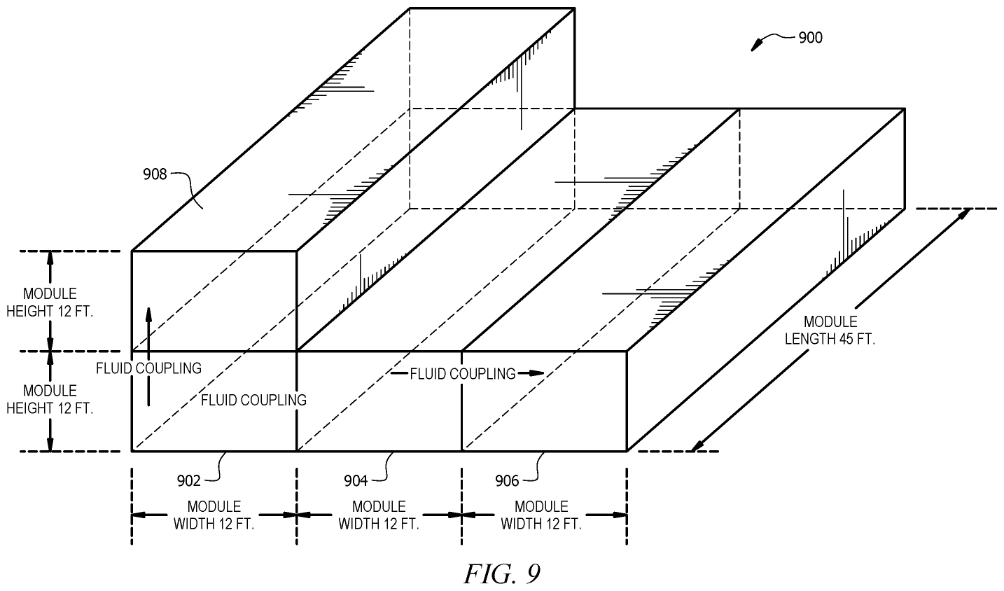

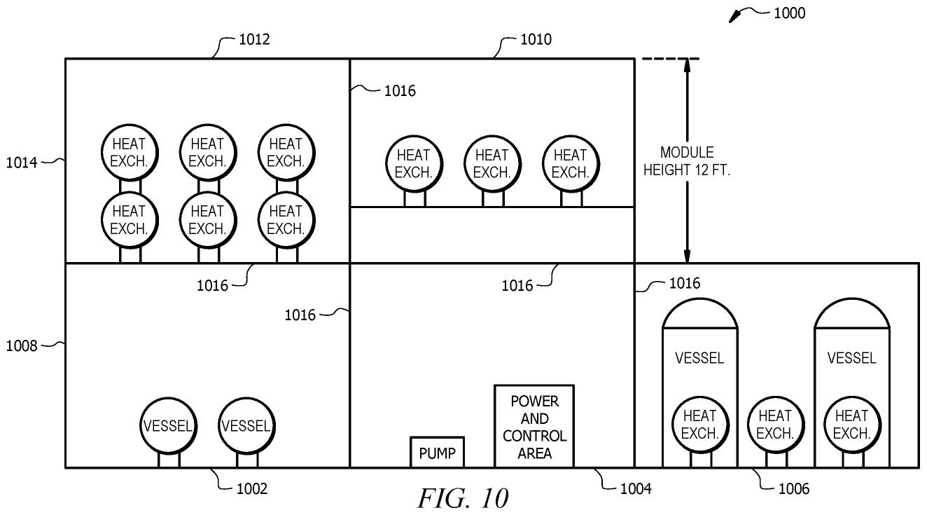

FIG. 9 is a schematic of a process block module layout elevation view 900, in which modules 902, 904, and 906 are on one level, most likely ground level, with a fourth module 908 disposed atop module 902. Although only two fluid couplings (arrows between modules) are shown, FIG. 9 should be understood to potentially include one or more additional fluid couplings, and one or more electrical and control couplings. This example (as well as others below) may help to illustrate that process blocks and/or modules within process blocks may be oriented/arranged/laid-out three dimensionally, with stacking for example.

FIG. 10 is a schematic of oil treating process block 1000, showing three modules 1002, 1004, and 1006, positioned on first level/story 1008, plus two additional modules 1010 and 1012 disposed in a second level/story 1014. Each module 1002, 1004, 1006, 1010, and 1012 may include equipment and/or connections/couplings as described above. Oil treating process block 1000 also illustrates envelopes 1016 to allow for internal connections between adjacent modules.

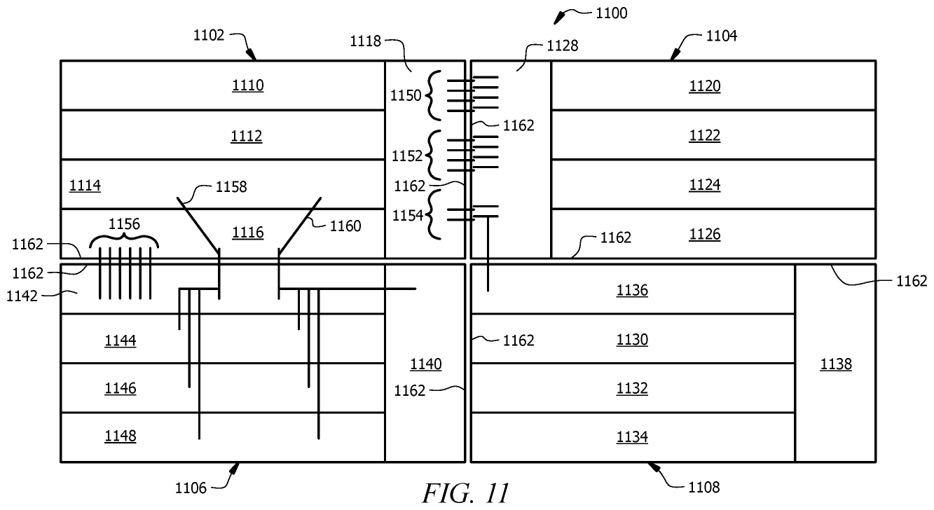

FIG. 11 is a schematic of a 3rd Generation Modular facility 1100 having four process blocks 1102, 1104, 1106, and 1108, each of which has five modules. Process block 1102 includes modules 1110,1112, 1114, 1116, 1118. Process block 1104 includes modules 1120, 1122, 1124, 1126, and 1128. Process block 1106 includes modules 1140, 1142, 1144, 1146, and 1148. Process block 1108 includes modules 1130, 1132, 1134, 1136, and 1138. Although dimensions are not shown, each of the modules should be interpreted as having (a) a length of at least 15 meters, (b) a height greater than 4 meters, (c) a width greater than 4 meters, and (d) having open sides and/or ends where the modules within a given process block are positioned adjacent to one another. In this particular example, process blocks 1102 and 1104 are fluidly coupled by fluid lines 1150, electrical lines 1152, and control lines 1154. Process blocks 1102 and 1106 are connected by fluid lines 1156, and by electrical line 1158 and control line 1160. Envelopes 1162 allow for internal connections for electricity, controls, and/or fluid between modules. Each module includes an envelope 1162.

Also in FIG. 11, a primary electrical supply (electrical line 1158) from process block 1102 fans out to four of the five modules of process block 1106, and control line 1160 from process block 1102 fans out to all five of the modules of process block 1106.

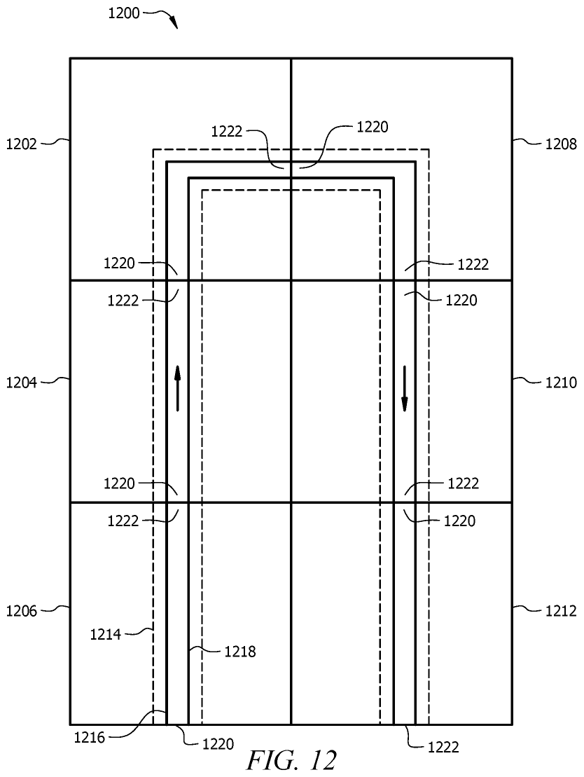

FIG. 12 is a schematic of a 3^{rd} Gen Modular facility 1200 having six process blocks 1202, 1204, 1206, 1208, 1210, and 1212. As previously described, in some embodiments, one or more of the fluid lines interconnecting the inputs and outputs of the 3^{rd} Gen process blocks are routed through a central piping spine 1214 that runs through at least portions of the processing facility (and particularly through and within at least some of the plurality of the process blocks). The embodiment of FIG. 12 shows a piping spine 1214 that extends through each of the process blocks. In this embodiment, piping spine 1214 also carries a plurality of interconnecting fluid lines 1216 and/or electrical lines 1218 that connect the inputs 1220 and outputs 1222 of each process block, as shown. Specifically, in some embodiments, piping spine 1214 carries pipes or other conduits that interconnect the output of process block 1206 to the input of process block 1204, the output of process block 1204 to the input of process block 1202, the output of process block 1202 to the input of process block 1208, the output of process block 1208 to the input of process block 1210, and finally the output of process block 1210 to the input of process block 1212. As a result, piping spine 1214 provides a main corridor for interconnecting the inputs 1220 and outputs 1222 for each of the adjacent process blocks, for at least the main processing flow. In addition, in this embodiment piping spine 150 can carry a plurality of utility lines that are coupled to the process blocks 1202-1212 (and therefore carry various utility fluids to process blocks 1202-1210 as previously described above). Further, each of the fluid lines (e.g., pipes, conduits, etc.) interconnecting the equipment within each process block 1202-1212 and the E+I lines routed throughout each process block 1202-1212 are not routed through the piping spine 1214 and are instead routed exclusively within the corresponding process block itself (i.e., within the geographic boundary defined by the corresponding process block 1202-1212), typically in a more direct manner.

Having described above various system/facility and method embodiments, various additional embodiments may include, but are not limited to the following:

In a first embodiment, a modular processing facility/system, comprising: a plurality (for example, at least 3) (modular) process blocks; wherein the plurality of (e.g., at least 3) process blocks are non-identical process blocks (e.g., each configured for a different process) (e.g., not simply multiple, substantially identical modules, for example in parallel); wherein the plurality of (e.g., at least 3) process blocks each comprise one or more transportable modules (which are configured to jointly achieve the process of the corresponding process block); and wherein the plurality of (e.g., at least 3) process blocks are not laid out on a (common) (external) piperack backbone for interconnecting process blocks (or modules) (e.g., no external interconnecting piperack between/linking/interconnecting the process blocks) (e.g., the process blocks are directly interconnected (without intervening piperack therebetween, for example, such that the interconnections between process blocks are disposed entirely within an envelope of the process blocks—for example, with interconnections between a first and a second of the at least 3 process blocks being located entirely within envelopes of the first and second process blocks). In a second embodiment, the system/facility of the first embodiment, wherein each of the plurality of (e.g., at least 3) process blocks is configured based on a process-based approach (e.g., to achieve a specific stand-alone process) (e.g., not equipment-based). In a third embodiment, the system/facility of embodiments 1-2, wherein the process blocks are close coupled to minimize interconnects and/or to reduce overall footprint of the facility. In a fourth embodiment, the system/facility of embodiments 1-3, wherein each of the plurality of (e.g., at least 3) process blocks comprises its own integral E+I Distribution (for example, thereby eliminating home run interconnecting cabling through traditional interconnecting racks). In a fifth embodiment, the system/facility of embodiments 1-4, wherein each of the plurality of (e.g., at least 3) process blocks is configured to allow for independent pre-commissioning, check-out, and/or commissioning (e.g., with respect to E+I) of a corresponding process system (for example, without connection to any other of the at least 3 process blocks) (for example, at a location separate and apart from the ultimate site of the facility, such as a mod yard) (for example, due to integral E+I, process block design approach, and/or lack of external interconnecting piperack). In a sixth embodiment, the system/facility of embodiments 1-5, wherein each of the plurality of (e.g., at least 3) process blocks comprises integral pipeways for utility distribution (and process block interconnects). In a seventh embodiment, the system/facility of embodiments 1-6, wherein each of the plurality of (e.g., at least 3) process blocks is located/arranged in proximity to (e.g., without intervening process blocks, modules, and/or piperacks therebetween) one or more other of the at least 3 process blocks (for example, with all process blocks forming a contiguous geographic footprint for the facility as a whole based on abutting process blocks). In an eighth embodiment, the system/facility of embodiments 1-7, wherein each of the plurality of (e.g., at least 3) process blocks is interconnected to one or more other of the at least 3 process blocks, and wherein the interconnects include fluid (e.g., piping). In a ninth embodiment, the system/facility of embodiments 1-8, wherein each of the plurality of (e.g., at least 3) process blocks is positioned/arranged in proximity to the other of the plurality of (e.g., at least 3) process blocks to which it directly interconnects, without intervening external piperacks and/or process blocks therebetween. In a tenth embodiment, the system/facility of embodiments 1-9, wherein each of the plurality of (e.g., at least 3) process blocks abuts at least one other of the process blocks. In an eleventh embodiment, the system/facility of embodiments 1-10, wherein the interconnections between process blocks are disposed entirely within the envelope of abutting process blocks. In a twelfth embodiment, the system/facility of embodiments 1-11, wherein each (or alternatively, some) of the transportable modules for the process blocks is sized as a truckable module. In a thirteenth embodiment, the system/facility of embodiments 1-12, wherein each of the plurality of process blocks comprises a plurality of transportable or truckable modules, which jointly may be configured to achieve the process for the corresponding process block. In a fourteenth embodiment, the system/facility of embodiments 1-13, wherein each process block is configured to allow for independent pre-commissioning, check-out, and/or commissioning (e.g., without being connected to another one or more of the process blocks) (e.g., at a site separate and apart from the ultimate facility site). In an additional embodiment, the system/facility of embodiments 1-14 might have all adjacent process blocks abut one another. In yet another embodiment, the system/facility of any of the embodiments above might be configured for a cracker facility, for example including any one or more of the following: the process blocks comprising seven or more (or alternatively two or more, three or more, five or more, ten or more, or all) of the following—an ethane cracking furnace process block, a steam generation process block, a water quench process block, a water stripper/dilution stream process block, a cracked gas compression process block, a caustic treatment process block, a drying process block, a deethanizer process block, an acetylene conversion process block, a demethanizer process block, a refrigeration process block, and/or a C₂ splitter process block; in which such process blocks are laid-out/arranged in one or more of the following: the ethane cracker furnace process block being (side-to-side) adjacent to (or abutting) the water quench process block; the water quench process block being (side-to-side) adjacent to (or abutting) the cracked gas compression process block; the caustic treatment process block being (side-to-side) adjacent to (or abutting) the drying process block; the drying process block being (side-to-side) adjacent to (or abutting) the deethanizer process block; the deethanizer process block being (side-to-side) adjacent to (or abutting) the acetylene conversion process block; the acetylene conversion process block being (side-to-side) adjacent to (or abutting) the demethanizer process block; the demethanizer process block being (side-to-side) adjacent to (or abutting) the refrigeration process block; the refrigeration process block being (side-to-side) adjacent to (or abutting) the C₂ splitter process block; in which the process blocks are interconnected (in flow, for example) in one or more of the following ways: the output stream from the cracked gas compression process block flowing into the caustic treatment process block; two-way flow between the cracked gas compression process block and the caustic treatment process block (so compression occurs before and after caustic treatment, prior to flow into the drying process block); the cracked gas compression process block being adjacent to (or abutting) the caustic treatment process block (wherein the adjacency/abutment could be side-to-side or diagonal in different embodiments); the ethane feed (into the facility) being heated by the ethane cracking furnace process block; the output stream from the ethane cracking furnace process block being sent to the water quench process block for cooling; the water quench process block possibly interacting with the water stripper process block to form a dilution stream which interacts with the ethane cracking furnace process block; the cooled output stream from the water quench process block sent to the cracked gas compression process block; the output steam from the cracked gas compression process block being sent to the caustic treatment process block; the caustic treatment process block interacting with the cracked gas compressor process block in a two-way manner (such that the stream is compressed before and after caustic treatment); the (final) outlet stream from the caustic treatment process block being sent to the drying process block to be dried (and oftentimes cooled); the output stream from the drying process block being sent to the deethanizer process block; the (overhead) output stream from the deethanizer process block being sent to the acetylene converter process block; the output stream from the acetylene converter process block being sent to the demethanizer process block, the refrigeration process block providing refrigerant to the cold box for the demethanizer process block; the output stream from the demethanizer process block sent to the C₂ splitter process block; the ethylene from the C₂ splitter process block being sent to the refrigeration process block; the process/facility output stream from the C₂ splitter block being ethylene (along with ethane that is recycled back to the ethane feed into the ethane cracking furnace); the process/facility output stream also including light pygas and/propylene; all process blocks adjacent or abutting side-to-side (with respect to the flow between process blocks, for example such that the flow between process blocks passes from a side of one process block into a side of a second interconnected process block); and/or no more than one (or two or three alternatively) process blocks diagonally adjacent or abutting with respect to the flow between process blocks (for example, no more than one, two, or three process blocks interconnected via flow in a diagonally adjacent/abutting manner). Any or all variants/steps described with respect to FIGS. 4-7 above can be included in any combination in such cracker-specific systems/facilities.

In a fifteenth embodiment, a modular method of constructing a processing facility (for example, for forming any one of the modular processing facilities/systems described above), comprising: arranging a plurality of process blocks (e.g., at least 3 process blocks) with respect to one another; wherein the plurality of (e.g., at least 3) process blocks are non-identical process blocks (e.g., each configured for a different process) (e.g., not simply multiple, substantially identical modules, for example in parallel); wherein the plurality of (at least 3) process blocks each comprise one or more transportable modules (e.g., typically a plurality of transportable or truckable modules for each process block) (e.g., which are configured to jointly achieve the process of the corresponding process block); and wherein the plurality of (e.g., at least 3) process blocks are not laid out on an (external) piperack backbone for interconnecting process blocks (or modules) (e.g., no external interconnecting piperack between/linking/interconnecting the 3 process blocks) (e.g., process blocks are directly interconnected (without intervening piperack there between, for example such that the interconnections between process blocks are disposed entirely within an envelope of the process blocks—for example, with the interconnections between a first and a second of the at least 3 process blocks being located entirely within the envelopes of the first and second process blocks)). In a sixteenth embodiment, the method of embodiment 15, further comprising: constructing one or more (for example, each or all) of the plurality of (e.g., at least 3) process blocks at one or more location different (remote/away) from the ultimate site of the processing facility (for example, a fab or mod yard); and pre-commissioning, check-out, and/or commissioning (for example of E+I) of a corresponding process system for the one or more process block(s) constructed away from the ultimate facility site (e.g., at the site of construction for such one or more process blocks) (for example, at the fab or mod yard) (for example, without connection to any other of the at least 3 process blocks) (for example at a location separate and apart from the ultimate site of the facility, such as a mod yard) (for example, due to integral E+I, process block design approach, and/or lack of the external interconnecting piperack). In a seventeenth embodiment, the method of embodiments 15-16, further comprising directly interconnecting (e.g., without the external interconnecting piperack) each process block to one or more adjacent process blocks (e.g., without intervening external piperacks and/or other process blocks there between). In an eighteenth embodiment, the method of embodiments 15-17, further comprising, close coupling one or more (for example, all) of the at least 3 process blocks (for example, to reduce overall footprint of the facility and/or reduce/minimize interconnects). In a nineteenth embodiment, the method of embodiments 15-18, further comprising designing/configuring each process block to accomplish a corresponding process (and laying out equipment in the modules making up each process block accordingly). In a twentieth embodiment, the method of embodiments 1-19, the method further comprising providing (e.g., at the one or more location different (remote/away) from the ultimate site of the processing facility (for example, a fab or mod yard)) integral E+I distribution for each of the at least 3 process blocks (e.g., to eliminate home run interconnecting cabling). In a twenty-first embodiment, wherein each of the process blocks comprises its own integral E+I Distribution/System. In a twenty-second embodiment, the method of embodiments 15-21, wherein arranging a plurality of process blocks (e.g., at least 3 process blocks) with respect to one another comprises positioning each process block so that it abuts any of the other process blocks to which it is connected (e.g., to form a contiguous geographic footprint for the facility based on abutting process blocks). In a twenty-third embodiment, the method of embodiments 15-22 wherein each of the plurality of (e.g., at least 3) process blocks is configured to allow for independent pre-commissioning, check-out, or commissioning of a corresponding process system (for example, with respect to E+I and/or with each such process block being configured with multiple types of equipment in order to allow for the corresponding process system to run independently of the other process blocks (e.g., without interacting with other, outside equipment in the midst of performing the process) to perform its process, for example using only feeds into the process (e.g., process block) for the process block to perform its corresponding process system (e.g., with no interaction with equipment or process blocks outside the process block to perform any portion of the process (e.g., within the internal system flow of the process—so that the only external interaction is for feeds to the entire process of the process block, and from there the process of the process block is self-contained))). In a twenty-fourth embodiment, the method of embodiments 15-23 further comprising beginning partial operation of the facility before all of the process blocks for the full facility are provided at the ultimate facility site and/or are interconnected (for example, operating a first process block independently while awaiting installation of a second process block; or operating a first and second (interconnected) process block while awaiting installation of a third process block; or operating a first, second, and third (interconnected) process block while awaiting installation of a fourth process block; etc.). In a twenty-fifth embodiment, the method of embodiments 1-24, for a cracker facility/system (for example comprising an ethane cracking furnace process block, a water quench process block, a water stripper process block, a cracked gas compression process block, a caustic treatment process block, a drying process block, a deethanizer process block, an acetylene conversion process block, a demethanizer process block, a refrigeration process block, and/or a C₂ splitter process block), wherein arranging (and or interconnecting) the process blocks with respect to one another comprises one or more of the following: the ethane cracker furnace process block being arranged, located, or placed (side-to-side) adjacent to (or abutting) the water quench process block; the water quench process block being arranged, located, or placed (side-to-side) adjacent to (or abutting) the cracked gas compression process block; the caustic treatment process block being arranged, located, or placed (side-to-side) adjacent to (or abutting) the drying process block; the drying process block being arranged, located, or placed (side-to-side) adjacent to (or abutting) the deethanizer process block; the deethanizer process block being arranged, located, or placed (side-to-side) adjacent to (or abutting) the acetylene conversion process block; the acetylene conversion process block being arranged, located, or placed (side-to-side) adjacent to (or abutting) the demethanizer process block; the demethanizer process block being arranged, located, or placed (side-to-side) adjacent to (or abutting) the refrigeration process block; the refrigeration process block being arranged, located, or placed (side-to-side) adjacent to (or abutting) the C₂ splitter process block; the output stream from the cracked gas compression process block being interconnected to flow into the caustic treatment process block; the cracked gas compression process block and the caustic treatment process block being interconnected for two-way flow between the cracked gas compression process block and the caustic treatment process block (so compression occurs before and after caustic treatment, prior to flow into the drying process block); the cracked gas compression process block being arranged, located, or placed adjacent to (or abutting) the caustic treatment process block (wherein the adjacency/abutment could be side-to-side or diagonal in different embodiments); the ethane feed (into the facility) being heated by the ethane cracking furnace process block; the output stream from the ethane cracking furnace process block being sent to the water quench process block for cooling; the water quench process block possibly interacting with the water stripper process block to form a dilution stream which interacts with the ethane cracking furnace process block; the cooled output stream from the water quench process block sent to the cracked gas compression process block; the output steam from the cracked gas compression process being sent to the caustic treatment process block; the caustic treatment process block interacting with the cracked gas compressor process block in a two-way manner (such that the stream is compressed before and after caustic treatment); the (final) outlet stream from the caustic treatment process block being sent to the drying process block to be dried (and oftentimes cooled); the output stream from the drying process block being sent to the deethanizer process block; the (overhead) output stream from the deethanizer process block being sent to the acetylene converter process block; the output stream from the acetylene converter process block being sent to the demethanizer process block, the refrigeration process block providing refrigerant to the cold box for the demethanizer process block; the output stream from the demethanizer process block sent to the C₂ splitter process block; the ethylene from the C₂ splitter process block being sent to the refrigeration process block; the process/facility output stream from the C₂ splitter being ethylene (along with ethane that is recycled back to the ethane feed into the ethane cracking furnace); the process/facility output stream also including light pygas and/propylene; all process blocks adjacent or abutting side-to-side (with respect to the flow between process blocks, for example such that the flow between process blocks passes from a side of one process block into a side of a second interconnected process block); and/or no more than one (or two or three alternatively) process block diagonally adjacent or abutting with respect to the flow between process blocks (for example, no more than one, two, or three process blocks interconnected via flow in a diagonally adjacent/abutting manner). In a twenty-sixth embodiment, the method of embodiments 1-25, for a cracker facility/system (for example comprising an ethane cracking furnace process block, a water quench process block, a water stripper process block, a cracked gas compression process block, a caustic treatment process block, a drying process block, a deethanizer process block, an acetylene conversion process block, a demethanizer process block, a refrigeration process block, and a C₂ splitter process block), wherein pre-commissioning, check-out and/or commissioning of the ethane cracking furnace process block comprises providing an ethane feed stream (input/feed stream source) to the ethane cracker furnace process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the ethane cracker furnace process block (for example, by evaluating the output stream (e.g., to ensure that the process block is performing within specification and/or regulations), for example, by measuring one or more characteristics of the output stream from the cracker furnace process block and comparing to a lookup table); wherein pre-commissioning, check-out and/or commissioning of the water quench process block comprises providing an input/feed stream source, e.g., emulating the ethane feed coming from the ethane cracker furnace, to the water quench process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the water quench process block (for example, by evaluating the output stream (e.g., to ensure that the process block is performing within specification and/or regulations), for example, by measuring one or more characteristics of the output stream of the water quench process block and comparing to a lookup table); wherein pre-commissioning, check-out and/or commissioning of the water stripper process block comprises providing an input/feed stream source, e.g., emulating the stream from the water quench interacting with the water stripper, to the water stripper process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the water stripper process block (for example, by evaluating the output stream (e.g., to ensure that the process block is performing within specification and/or regulations), for example, by measuring one or more characteristics of the output stream of the water stripper process block and comparing to a lookup table) wherein pre-commissioning, check-out and/or commissioning of the cracker gas compression process block comprises providing an input/feed stream source, e.g., emulating the input stream from the water quench, to the cracker gas compression process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the cracked gas compression process block (for example, by evaluating the output stream (e.g., to ensure that the process block is performing within specification and/or regulations), for example, by measuring one or more characteristics of the output stream of the cracked gas compression process block and comparing to a lookup table); wherein pre-commissioning, check-out and/or commissioning of the caustic treatment process block comprises providing an input/feed stream source, e.g., emulating the stream from the cracked gas compression, to the caustic treatment process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the caustic treatment process block (for example, by evaluating the output stream (e.g., to ensure that the process block is performing within specification and/or regulations), for example, by measuring one or more characteristics of the output stream of the caustic treatment process block and comparing to a lookup table); wherein pre-commissioning, check-out and/or commissioning of the drying process block comprises providing an input/feed stream source, e.g., emulating stream from caustic treatment, to the drying process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the drying process block (for example, by evaluating the output stream (e.g., to ensure that the process block is performing within specification and/or regulations), for example, by measuring one or more characteristics of the output stream of the drying process block and comparing to a lookup table); wherein pre-commissioning, check-out and/or commissioning of the deethanizer process block comprises providing an input/feed stream source, e.g., emulating the stream from drying, to the deethanizer process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the deethanizer process block (for example, by evaluating the output stream (e.g., to ensure that the process block is performing within specification and/or regulations), for example, by measuring one or more characteristics of the output stream of the deethanizer process block and comparing to a lookup table); wherein pre-commissioning, check-out and/or commissioning of the acetylene conversion process block comprises providing an input/feed stream source, e.g., emulating the stream from the deethanizer, to the acetylene conversion process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the acetylene conversion process block (for example, by evaluating the output stream (e.g., to ensure that the process block is performing within specification and/or regulations), for example, by measuring one or more characteristics of the output stream of the acetylene conversion process block and comparing to a lookup table); wherein pre-commissioning, check-out and/or commissioning of the demethanizer process block comprises providing an input/feed stream source, e.g., emulating the stream from the acetylene conversion, to the demethanizer process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the demethanizer process block (for example, by evaluating the output stream (e.g., to ensure that the process block is performing within specification and/or regulations), for example, by measuring one or more characteristics of the output stream of the demethanizer process block and comparing to a lookup table); wherein pre-commissioning, check-out and/or commissioning of the refrigeration process block comprises providing an input/feed stream source. e.g., emulating the stream from the C₂ splitter, to the refrigeration process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the refrigeration process block (for example, by evaluating the output stream (e.g., to ensure that the process block is performing within specification and/or regulations), for example, by measuring one or more characteristics of the output stream of the refrigeration process block and comparing to a lookup table); and/or wherein pre-commissioning, check-out and/or commissioning of the C₂ splitter process block comprises providing an input/feed stream source, e.g., emulating the stream from the demethanizer, to the C₂ splitter process block (when the process block is not interconnected with any other process blocks and/or is not part of an entire/functional facility and/or is not located at the ultimate site of the facility, but is located at the one or more location different (remote/away) from the ultimate site of the processing facility) and/or evaluating the performance of the C₂ splitter process block (for example, by evaluating the output stream (e.g., to ensure that the process block is performing within specification and/or regulations), for example, by measuring one or more characteristics of the output stream of the C₂ splitter process block and comparing to a lookup table). In a twenty-seventh embodiment, the method of embodiment 26 wherein the input/feed stream is provided to the process block being pre-commissioned, checked-out, and/or commissioned by an independent, stand-alone source (such as a tank and/or additional equipment to place the stream in proper condition to mimic the input when the process block is connected to the other process blocks in a functional facility that is running in operational mode) and/or is not provided by another process block and/or is located at the one or more location different (remote/away) from the ultimate site of the processing facility. In another embodiment, the method of any of the embodiments above, wherein the pre-commissioning, check-out and/or commissioning of each process block (e.g., for the cracker facility) with respect to E+I may take place remotely (e.g., at a location separate and apart (e.g., distant) from the ultimate site of the facility and/or from one or more (or all) of the other process blocks for the facility) and/or without connection to any other process blocks and/or modules and/or equipment for the facility and/or using the independent E+I corresponding to each process block and/or may involve one or more of the exemplary steps shown in Table 2 above.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

Accordingly, the scope of protection is not limited by the description set out above, but is defined by the claims which follow that scope including all equivalents of the subject matter of the claims. In the claims, any designation of a claim as depending from a range of claims (for example #-##) would indicate that the claim is a multiple dependent claim based on any claim in the range (e.g., dependent on claim # or claim ## or any claim therebetween). Each and every claim is incorporated as further disclosure into the specification, and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises”, “includes”, and “having” should be understood to provide support for narrower terms such as “consisting of”, “consisting essentially of”, and “comprised substantially of”. Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A modular processing facility, comprising:
at least 3 process blocks;
wherein the at least 3 process blocks are non-identical process blocks;
wherein the at least 3 process blocks each comprise one or more modules;
wherein each process block of the at least 3 process blocks is interconnected to one or more of the other at least 3 process blocks; and
wherein the at least 3 process blocks comprise the following: an ethane cracking furnace, a steam generation process, a water stripper, a water quench, a compression, a caustic scrubber, a drier, a deethanizer, an acetylene conversion, a demethanizer, a refrigerator, or a splitter,
wherein the at least 3 process blocks comprise a compression process block, a caustic treatment process block, a drier process block, an acetylene conversion process block, and a deethanizer process block;
wherein the compression process block abuts at least the caustic treatment process block;
wherein the drier process block abuts at least the caustic treatment process block; and
wherein the acetylene conversion process block abuts at least the deethanizer process block.

2. The modular processing facility of claim 1, wherein each of the at least 3 process blocks comprises its own integral E+I Distribution/System, and wherein each of the at least 3 process blocks is configured to allow for independent pre-commissioning, check-out, or commissioning of E+I.

3. The modular processing facility of claim 1, wherein the process blocks are closely coupled to minimize interconnects and to reduce overall footprint of the facility.

4. The modular processing facility of claim 1, wherein each process block of the at least 3 process blocks is positioned in proximity to the other of the at least 3 process blocks to which it directly interconnects, without intervening external piperacks or process blocks therebetween.

5. The modular processing facility of claim 1, wherein each process block of the at least 3 process blocks abuts at least one other of the at least 3 process blocks, and wherein the interconnections between process blocks are disposed entirely within the envelope of abutting process blocks.

6. The modular processing facility of claim 1, wherein the at least 3 process blocks are not laid out on a piperack backbone for interconnecting process blocks or modules, such that there is no external interconnecting piperack interconnecting any of the at least 3 process blocks; and wherein each of the at least 3 process blocks is configured based on a process-based approach.

7. (canceled)

8. A method of constructing a modular facility, the method comprising:
arranging a plurality of process blocks with respect to one another, wherein the plurality of process blocks are non-identical process blocks, wherein the plurality of process blocks each comprise one or more modules, and wherein the plurality of process blocks comprise at least 3 of: an ethane cracking furnace process block, a water quench process block, a water stripper process block, a cracked gas compression process block, a caustic treatment process block, a drying process block, a deethanizer process block, an acetylene conversion process block, a demethanizer process block, a refrigeration process block, or a C2 splitter process block;
directly interconnecting each process block to one or more adjacent process blocks; and
configuring each process block to accomplish a corresponding process.

9. The method of claim 8, further comprising providing integral E+I distribution for each of the plurality of process blocks; wherein each of the plurality of process blocks comprises its own integral E+I Distribution/System.

10. The method of claim 9, further comprising:
constructing one or more of the plurality of process blocks at a location different from the ultimate site of the processing facility; and
pre-commissioning, check-out, or commissioning of the E+I system for the one or more process blocks constructed away from the ultimate facility site at a location separate and apart from the ultimate site of the facility.

11. The method of claim 10, wherein the pre-commissioning, check-out, or commissioning of E+I for the one or more process blocks occurs without connection of each such one or more process block to any other of the plurality of process blocks for the facility.

12. The method of claim 8, wherein the plurality of process blocks are not laid out on a piperack backbone for interconnecting process blocks, such that there is no external piperack interconnecting the plurality of process blocks.

13. The method of claim 8, wherein the plurality of process blocks comprise: the ethane cracking furnace process block, the water quench process block, the water stripper process block, the cracked gas compression process block, the caustic treatment process block, the drying process block, the deethanizer process block, the acetylene conversion process block, the demethanizer process block, the refrigeration process block, and the C₂ splitter process block, and wherein arranging and/or interconnecting the process blocks with respect to one another comprises one or more of the following:
wherein the ethane cracker furnace process block is arranged, located, or placed adjacent to the water quench process block;
wherein the water quench process block is arranged, located, or placed adjacent to the cracked gas compression process block;
wherein the caustic treatment process block is arranged, located, or placed adjacent to the drying process block;
wherein the drying process block is arranged, located, or placed adjacent to the deethanizer process block;
wherein the deethanizer process block is arranged, located, or placed adjacent to the acetylene conversion process block;
wherein the acetylene conversion process block is arranged, located, or placed adjacent to the demethanizer process block;
wherein the demethanizer process block is arranged, located, or placed adjacent to the refrigeration process block;
wherein the refrigeration process block is arranged, located, or placed adjacent to the C₂ splitter process block;
wherein the output stream from the cracked gas compression process block is interconnected to flow into the caustic treatment process block;

14. The method of claim 13, wherein arranging and/or interconnecting the process blocks with respect to one another further comprises one or more of the following:
wherein the cracked gas compression process block and the caustic treatment process block are interconnected for two-way flow between the cracked gas compression process block and the caustic treatment process block;
wherein the cracked gas compression process block is arranged, located, or placed adjacent to the caustic treatment process block;
wherein the ethane feed is heated by the ethane cracking furnace process block;
wherein the output stream from the ethane cracking furnace process block is sent to the water quench process block for cooling;
wherein the water quench process block interacts with the water stripper process block to form a dilution stream which interacts with the ethane cracking furnace process block;
wherein the cooled output stream from the water quench process block is sent to the cracked gas compression process block;
wherein the output steam from the cracked gas compression process is sent to the caustic treatment process block;
wherein the caustic treatment process block interacts with the cracked gas compressor process block in a two-way manner;
wherein the outlet stream from the caustic treatment process block is sent to the drying process block to be dried;
wherein the output stream from the drying process block is sent to the deethanizer process block;
wherein the output stream from the deethanizer process block is sent to the acetylene converter process block;
wherein the output stream from the acetylene converter process block is sent to the demethanizer process block;
wherein the refrigeration process block provides refrigerant to the cold box for the demethanizer process block;
wherein the output stream from the demethanizer process block is sent to the C₂ splitter process block;
wherein the ethylene from the C₂ splitter process block is sent to the refrigeration process block; and
wherein the process/facility output stream from the C₂ splitter comprises ethylene.

15. A facility comprising:
a first process block, a second process block, and a third process block,
wherein the first process block, the second process block, and the third process block are coupled together;
wherein at least 3 transportable modules are used to collectively compose the first process block, the second process block, and the third process block;
wherein each of the first process block, the second process block, and the third process block is fluidly and electrically coupled to at least one other of the first process block, the second process block, and the third process block using direct-module-to-module connections,
wherein no external piperack interconnects the first process block, the second process block, and the third process block;
wherein the first process block is positioned adjacent to each of the second process block and the third process block; and
wherein the first process block is configured to carry out a first process and the second process block is configured to carry out a second process different from the first process,
wherein the first process block, the second process block, and the third process block comprise two or more of the following—an ethane cracking furnace process block, a steam generation process block, a water quench process block, a water stripper/dilution stream process block, a cracked gas compression process block, a caustic treatment process block, a drying process block, a deethanizer process block, an acetylene conversion process block, a demethanizer process block, a refrigeration process block, a C₂ splitter process block.

16. The facility of claim 15, wherein each of the first process block, the second process block, and the third process block comprises its own integral E+I Distribution and is configured to allow for independent pre-commissioning, check-out, or commissioning of E+I.

17. (canceled)

18. The facility of claim 15, wherein the ethane cracker furnace process block is adjacent to the water quench process block; the water quench process block is adjacent to the cracked gas compression process block; the caustic treatment process block is adjacent to the drying process block; the drying process block is adjacent to the deethanizer process block; the deethanizer process block is adjacent to the acetylene conversion process block; the acetylene conversion process block is adjacent to the demethanizer process block; the demethanizer process block is adjacent to the refrigeration process block; and/or the refrigeration process block is adjacent to the C₂ splitter process block.

19. The facility of claim 18, wherein the first process block, the second process block, and the third process block are adjacent side-to-side.

20. The facility of claim 18, wherein at least one but no more than one set of adjacent process blocks are diagonally adjacent with respect to the flow between process blocks.
